(19) United States
(12) Patent Application Publication
(10) Pub. No.: US 2015/0379644 A1
(43) Pub. Date: Dec. 31, 2015

(54) SYSTEMS AND METHODS FOR IDENTIFYING AND REMEDYING ACCOUNT ERROR EVENTS IN NETWORKED COMPUTER SYSTEMS

(71) Applicant: The Toronto-Dominion Bank, Mississauga (CA)

(72) Inventors: Jakub DANIELAK, Toronto (CA); Lauren VAN HEERDEN, Bedford, NH (US); Gunalan NADARAJAH, Milton (CA); Orin DEL VECCHIO, Richmond Hill (CA); Paul Mon-Wah CHAN, Markham (CA); Jonathan K. BARNETT, Oakville (CA); Ashraf METWALLI, Toronto (CA); Matthew HAMILTON, Toronto (CA); Clara BOR, Mississauga (CA); Wallace BARBOUR, Mississauga (CA)

(73) Assignee: The Toronto-Dominion Bank

(21) Appl. No.: 14/755,740

(22) Filed: Jun. 30, 2015

Related U.S. Application Data
(60) Provisional application No. 62/019,031, filed on Jun. 30, 2014.

(51) Int. Cl. G06Q 40/06; G06Q 20/10

(52) U.S. Cl. CPC G06Q 40/06; G06Q 20/108

(57) ABSTRACT

The disclosed embodiments include computerized methods and system for detecting error events, such as account shortfalls, within networked computer systems operated by the financial institutions and other business entities. In one aspect, a system includes a memory storing instructions and one or more processors configured to execute the instruction to perform operating, such as receiving a payment request for a payment amount from a first account of a user to a destination account. The operations may also include determining that the first account lacks sufficient funds to cover the payment amount, and determining that the user has pre-approved a credit line account secured by a first set of investment holdings of the user that generate revenue that is periodically transferred to the first account. The operations may also include performing a fund transfer operation for the payment amount from the credit line account to the first account.

### CROSS-REFERENCE TO RELATED APPLICATION

This application claims the benefit of U.S. Provisional Patent Application No. 62/019,031, filed Jun. 30, 2014, which is expressly incorporated by reference herein, in its entirety.

### BACKGROUND

1. Technical Field

The present disclosure relates to computerized systems and methods that identify and remedy error events within networked computer systems, and without limitation, methods and systems that identify and remedy shortfall events associated with stored account data within networked computer systems operated by financial institutions and other entities.

2. Background Information

Many banking customers make use of scheduled automated fund transfers to make sure that payments are made timely. Automated fund transfer technologies, such as online bill payment services, etc., allow users to make periodic payments towards bills without having to perform payment operations each billing cycle. For instance, sweep accounts may be set up to transfer funds into an investment vehicle when a minimum balance is exceeded. If there is a shortfall, the same investment vehicles may have to be liquidated to maintain the minimum balance. While helpful in this regard, conventional automated fund transfer technologies require that a user carefully monitor the balance of their account to ensure that the source account has sufficient funds to make the automated transfer. Automated fund transfer technologies attempt to address this issue through overdraft protection mechanisms, which may allow a financial service provider to use funds from another account (e.g., a savings account) to provide funds when a source account has a shortfall. Such mechanisms, however, are limited. For example, they may require a user to maintain secondary cash accounts with the same financial service provider (e.g., savings accounts), and may be unavailable to users with no liquid assets. Thus, in situations where an expectation of a regular draw on funds exists, conventional systems and processes are not configured to cover a minimum balance through anything other than the liquidation of assets or some other form of manual intervention by the advisor or administrator.

### SUMMARY

The disclosed embodiments include computerized methods and systems that identify and remedy error events, such shortfall events associated with stored account data, within networked computer systems operated by the financial institutions and other business entities without requiring user intervention.

For example, the disclosed embodiments include a system that includes a memory storing instructions and one or more processors configured to execute the instruction to perform operations. The operations may include identifying a scheduled funds transfer from an investment account of a user to a destination account. The scheduled funds transfer may, in one aspect, be associated with a funds transfer amount determined based on expected periodic returns from the investment account. The operations may also include determining a shortfall amount associated with a shortfall event. In some aspects, the shortfall event may indicate that the funds transfer amount exceeds an amount of funds available from the investment account, and further, the shortfall amount may reflect a difference between the amount of available funds and the funds transfer amount. Furthermore, the operations may include establishing a shortfall account for the user that includes a credit facility providing at least the shortfall amount, and performing operations that trigger a funds transfer of at least a first portion of the shortfall amount from the shortfall account to the destination account. The operations may include determining a repayment schedule for the shortfall account, based on excess funds remaining after one or more future scheduled funds transfers.

The disclosed embodiments may also include a device that includes a memory storing instructions and one or more processors configured to execute the instruction to perform operations. The operations may include obtaining user registration information reflecting a request by a user for a shortfall account. In some aspects, the investment account may be associated with a scheduled funds transfer of a funds transfer amount determined based on expected periodic returns from the investment account to a destination account. The operations may also include providing the request for the shortfall account to a computing system associated with a financial institution. The computing system may, in one aspect, be connected to the device across a corresponding communications network. Further, the operations include receiving, from the computing system, a shortfall event notification of a shortfall event indicating that the funds transfer amount exceeds an amount of funds available from the investment account. The operations may also include receiving, from the computing system, a shortfall account payment notification that a shortfall account payment was made from the investment account to the shortfall account of a first excess fund amount that reflects at least a portion of the difference between the funds transfer amount and the amount of available funds following a deposit amount to the investment account subsequent to the shortfall event. In addition, the operations may include receiving, from the computing system, shortfall repayment schedule information reflecting a repayment schedule for the shortfall account. The repayment schedule may, in certain aspects, be based on excess funds remaining after future scheduled funds transfers from the investment account to the destination account. The operations may also include generating one or more instructions to present the received shortfall account payment notification and shortfall repayment schedule information to the user.

The disclosed embodiments also include a computer-implemented method that includes identifying, by one or more processors, a scheduled funds transfer from an investment account of a user to a destination account. The scheduled funds transfer may be associated with a funds transfer amount determined based on expected periodic returns from the investment account. The method may also include determining, by the one or more processors, a shortfall amount associated with a shortfall event. In some aspects, the shortfall event may indicate that the funds transfer amount exceeds an amount of funds available from the investment account, and the shortfall amount may reflect a difference between the amount of available funds and the funds transfer amount. The method may establish, by the one or more processors, a shortfall account for the user that includes a credit facility providing at least the shortfall amount. Additionally, the method includes performing, by the one or more processors, operations that trigger a funds transfer of at least a portion of the shortfall amount from the shortfall account to the destination account, and determining, by the one or more processors, a repayment schedule for the shortfall account, based on excess funds remaining after future scheduled funds transfers from the investment account to the destination account.

It is to be understood that both the foregoing general description and the following detailed description are exemplary and explanatory only, and are not restrictive of the disclosed embodiments as claimed. Further, the accompanying drawings, which are incorporated in and constitute a part of this specification, illustrate aspects of the present disclosure and together with the description, serve to explain principles of the disclosed embodiments as set forth in the accompanying claims.

### BRIEF DESCRIPTION OF THE DRAWINGS

FIG. 1 is a diagram of an exemplary computing environment, consistent with disclosed embodiments.

FIG. 2 is a block diagram associated with processes and data structures consistent with disclosed embodiments.

FIG. 3 is a flowchart of an exemplary registration process, consistent with disclosed embodiments.

FIG. 4 is a diagram of an exemplary registration interface, consistent with disclosed embodiments.

FIG. 5 is a flowchart of an exemplary financial account provisioning and repayment process, consistent with disclosed embodiments.

FIG. 6 is a flowchart of another exemplary financial account provisioning and repayment process, consistent with disclosed embodiments.

FIG. 7 is a flowchart of another exemplary financial account provisioning and repayment process, consistent with disclosed embodiments.

FIGS. 8-10 illustrate exemplary graphical user interfaces, consistent with disclosed embodiments.

### DESCRIPTION OF THE EMBODIMENTS

Reference will now be made in detail to embodiments of the present disclosure, examples of which are illustrated in the accompanying drawings. The same reference numbers will be used throughout the drawings to refer to the same or like parts.

In this application, the use of the singular includes the plural unless specifically stated otherwise. In this application, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, any information sections used herein are for organizational purposes only, and are not to be construed as limiting the subject matter described.

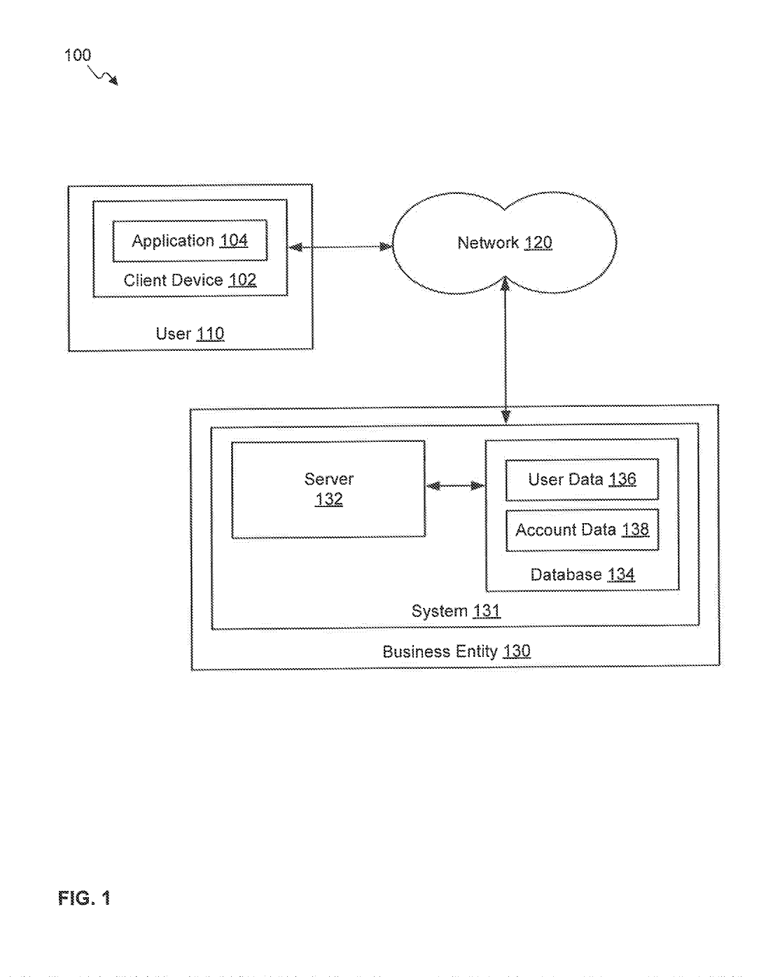

FIG. 1 illustrates an exemplary computing environment 100, consistent with certain disclosed embodiments. In one aspect, system 100 may include a client device 102, system 131, and a network 120.

In one embodiment, client device 102 may be a computing device, such as, but not limited to, a personal computer, a laptop computer, a tablet computer, a notebook computer, a hand-held computer, a personal digital assistant, a portable navigation device, a mobile phone, a smart phone, and any other type of computing device that may be configured to store data and software instructions, execute software instructions to perform operations, and/or display information on a display device(s), consistent with disclosed embodiments. In certain embodiments, client device 102 may be associated with one or more users, such as user 110. For instance, user 110 may operate client device 102 and may do so to cause client device 102 to perform one or more operations consistent with the disclosed embodiments.

Client device 102 may include known computing device components. For instance, client device 102 may include one or more memories that store data and/or software instructions, and one or more processors configured to execute software instructions. Client device 102 may include one or more display devices that display information to a user and one or more input device(s) to allow the user to input information to client device 102 (e.g., keypad, keyboard, touch screen, voice activated control technologies, or any other type of known input device). In one aspect, client device 102 may store in memory one or more software applications that run on client device 102 and are executed by the one or more processors. For instance, client device 102 may include Application 104 that may be software that, when executed by one or more processors, performs operations that allow user 110 (through client device 102) to interact with business entity 130 through, for example, a computing device, such as server 132 or other computing component(s)). In certain aspects, application 104 may perform operations, when executed, that cause client device 102 to send information to be stored in a memory remote to client device 102 and/or receive information stored in a memory remote to client device 102 (e.g., memory associated with server 132, such as database 134). The configuration of client device 102 is not limited to the above examples.

In one embodiment, business entity 130 may be any type of business entity that may provide financial account(s) to one or more users (e.g., customers of business entity 130). For instance, business entity 130 may be a financial institution, such as a bank, that provides and maintains financial account(s) for users (e.g., checking account(s), savings account(s), line of credit account(s), etc.). In one aspect, user 110 may be a customer or a potential customer of business entity 130. In other aspects, user 110 may be a customer that holds one or more financial accounts with business entity 130, such as a checking account, savings accounts, credit card account, debit accounts, line of credit accounts, and/or other types of accounts.

System 131 may be a computing system configured to execute software instructions to perform one or more operations consistent with disclosed embodiments. In one aspect, system 131 may be associated with business entity 130. System 131 may be a distributed system that may include computing components that are distributed across one or more networks, such as network 120, or other networks.

In one aspect, system 131 may include computing components known to those skilled in the art and configured to store, maintain, and generate data and software instructions. For example, system 131 may include one or more servers (e.g., server 132) and memory device(s) (e.g., database 134). Server 132 may be one or more computing device(s) (e.g., servers) that may be configured to execute software instructions to perform one or more processes consistent with the disclosed embodiments. In one example, server 132 may be a computing device that executes software instructions that perform operations that provides information to one or more other components of computing environment 100. In one embodiment, server 132 may include a general purpose computer (e.g., a personal computer, network computer, server, or mainframe computer) having one or more processors that may be selectively activated or reconfigured by a computer program. In one aspect, server 132 (or other computing components of system 131) may be configured to provide one or more websites, online portals, etc., that provide services consistent with business entity 130, such as an online banking portal, and services consistent with disclosed embodiments. For instance, server 132 may be configured to provide information associated with a requested web page over communications network 120 to client device 102, which may render the received information and present content from the web page on a display device. Additionally, server 132 may be incorporated as a corresponding node in a distributed network, and additionally or alternatively, as a corresponding networked server in a cloud-computing environment. Furthermore, server 132 may communicate via network 120 with one or more additional servers (not shown), which may facilitate the distribution of processes for parallel execution by the additional servers.

Database 134 may be one or more memories that are configured to store and provide access to data and/or software instructions. Such memories may include tangible non-transitory computer-readable mediums that store software instructions that, when executed by one or more processors (e.g., server 132), perform one or more operations consistent with disclosed embodiments. Database 134 may be configured to store information relating to business entity 130. For instance, database 134 may store financial account data associated with customers of business entity 130, such as user 110. In one example, the financial account data may include user data 136 and account data 138. In certain aspects, user data 136 may include personal information associated with a user (e.g., a user name, a home address, and a date of birth), government-issued identifiers (e.g., driver's license numbers and Social Security numbers), employment information (e.g., employer name and address), and contact information (e.g., email addresses, home numbers, work numbers, and mobile numbers). User data 136 may also include one or authentication credentials associated with registered users of the financial institution. For example, the authentication credentials may include, but are not limited to, a user name, a user-specified password, a system-generated password, or an alphanumeric identification number (e.g., a PIN number) specified by the user or assigned by business entity 130. Other types of user information may be stored and used by the disclosed embodiments.

Additionally or alternatively, user data 136 may include information facilitating enhanced authentication techniques. For example, customer data 144A may store information identifying a security question associated with the user (e.g., “What is your mother's maiden name?”) and the user's registered answer to that security question. User data 136 may also include information identifying a particular security image or avatar selected by the user and displayed by the user during an authentication process.

Further, in one embodiment, user data 136 may include user device identification information that identifies one or more devices registered to the user (e.g., client device 102 and user 110). In one embodiment, the user may provide the user device identification information (e.g., a mobile telephone number provided by the user when registering for online banking services), or alternatively, server 132 may be configured to execute processes that automatically collect user device identification information (e.g., collecting an Internet Protocol (IP) address associated with the user's smartphone).

In certain aspects, account data 138 may include account identification information identifying one or more accounts of users of the financial institution associated with business entity 130. In one embodiment, account identification information may include financial service account information, such as, for example, a checking account, a savings account, a revolving credit line, an account linked to a credit or debit card, a brokerage account, and any additional or alternate account provided or supported by the financial institution.

In certain aspects, information within account data 138 may identify, for a single customer, one or more accounts associated with the user and account data corresponding to the accounts (e.g., an account number, expiration date information, card security codes, account balance information, and/or credit limit information).

Although computing environment 100 is illustrated in FIG. 1 with client device 102 in communication system 131, persons of ordinary skill in the art will recognize that environment 100 may include any number of number of mobile or stationary client devices 102, and any additional number of computers, systems, or servers without departing from the spirit or scope of the disclosed embodiments. Further, although computing environment 100 is illustrated in FIG. 1 with a single business entity 130 and/or system 131, persons of ordinary skill in the art will recognize that environment 100 may include any number of additional number of business entities and corresponding systems, any number of additional number of servers and data repositories, and any additional number of computers, systems, servers, or server farms without departing from the spirit or scope of the disclosed embodiments.

Network 120 may represent any form or medium of digital data communication. Examples of network 120 include a local area network (“LAN”), a wireless LAN, a RF network, a Near Field Communication network, e.g., a “WiFi” network, a wireless Metropolitan Area Network (MAN) that connects multiple wireless LANs, and a wide area network (“WAN”), e.g., the Internet. Consistent with embodiments of the present disclosure, network 120 can include the Internet and include any publicly accessible network or networks interconnected via one or more communication protocols, including, but not limited to, hypertext transfer protocol (HTTP) and transmission control protocol/internet protocol (TCP/IP). Moreover, network 120 may also include one or more mobile device networks, such as a GSM network or a PCS network, that allow client devices, such as client device 102, to send and receive data via applicable communications protocols, including those described above.

The disclosed embodiments may include methods and systems for providing financial accounts that may be used to fund shortfalls relating to other accounts, such as payment accounts, etc. In certain aspects, the disclosed embodiments may provide mechanisms that establish or access one or more credit facilities, including credit and borrowing facilities offered by financial institutions and non-financial entities (e.g., funds from friends and family members, crowdsourcing, micro-financing, etc.) to make up periodic shortfalls related to the other accounts without requiring a sale of assets held within an investment portfolio. By way of example, credit facilities consistent with the disclosed embodiments may include a line of credit or similar financial account that may be secured against, for example, investment assets within an investment portfolio, to make up periodic shortfalls in payments without requiring the sale of portions of the assets. In other instances, the established or accessed credit facility may include, but are not limited to, a loan provided by the financial institution, various demand products offered by the financial institution, overdraft protection services provided by a financial institution for accounts impacted by the periodic shortfalls, and/or other borrowing facilities provided by financial institutions and similar entities.

The disclosed embodiments are, however, not limited to credit facilities provided by financial institutions and similar entities. In further aspects, the disclosed embodiments may provide mechanisms that establish or access one or more credit facilities provided by non-financial entities. By way of example, credit facilities provided by non-financial entities may include, but are not limited, funds borrowed from family members or close friends, funds obtained from crowdsourcing and other sources of syndicated investment funds, and funds obtained from micro-financing entities.

The disclosed embodiments may also be configured to perform processes that determine anticipated income from those assets and configure, generate, and perform a repayment process that may use the anticipated income to pay down an outstanding balance of the credit facility (e.g., the line of credit or similar financial account) used to make up the shortfalls. The disclosed embodiments may be configured to perform operations consistent with these and other aspects such that they are transparent to a user associated with the payment account(s), investment portfolio, and representatives of business entities that provide the accounts and/or advise on the investment assets and portfolio.

In certain exemplary embodiments, user 110 may have one or more investment accounts maintained by business entity 130 (or another business entity) that generate income. In one aspect, an investment account may be a financial account that generates income based on investment processes, such as a retirement account, stocks portfolios, bonds, guaranteed investment certificates (GICs), etc. In one aspect, an investment account may be associated with user 110 and configured to provide periodic income that may be deposited into one or more deposit financial accounts associated with user 110. In one embodiment, business entity 130 may provide the investment account and/or the deposit account for user 110. System 131 may be configured to store software instructions that, when executed by one or more processors, perform processes that manage the investment account and/or deposit accounts, and the deposit operations associated with such accounts. As an example, user 110 may hold a financial account that is a destination account (e.g., deposit target account) that is configured to receive periodic payments associated with income generated by the investment account (e.g., lump sum payments made bi-weekly, monthly, etc.).

In certain aspects, the disclosed embodiments may perform operations that allow regular payments generated based on interest earned on the investment account to be deposited into the deposit account. In certain instances, if an excess of funds exist in the investment account, the disclosed embodiments may be configured to reinvest the excess funds into the investments associated with the investment account and/or provide cash or electronic fund transfer payments, etc.

In certain instances, however, a shortfall may exist. A shortfall may be, for example, associated with a payment amount from the investment account that is less than expected or anticipated payment amounts generated by the investment account (e.g., no payment amount, negative payment amount, a reduced payment amount, etc.). For example, a shortfall may exist due to a temporary disruption in income and the entirety of a lump sum periodic payment may not be available for transfer (e.g., quarterly dividend payment has not been made, some of the user 110's GICs were liquidated, etc.).

The disclosed embodiments may be configured to identify a shortfall event, and perform operations that perform a fund transfer to cover the amount of the shortfall from the credit facility or similar account to the deposit account that is configured to receive the investment account payments. In certain aspects, the disclosed embodiments may perform processes that enable user 110 to apply for, request, receive, and configure the credit facility or similar account in advance of a shortfall event through system 131 and client device 102. The disclosed embodiments may also be configured to provide the shortfall event processes without requiring the sale of any of the user 110's investments relating to the investment account. In one aspect, the disclosed embodiments may perform processes that create and configure the credit facility or similar account for user 110 by securing the account based on the investment account (e.g., based on anticipated income generated by the investments associated with the investment account). In other aspects, the disclosed embodiments may be configured to generate and provide alerts and notifications to user 110 and/or a representative of business entity 130 (e.g., investment account advisor, etc.) that the shortfall event has occurred and a shortfall payment was initiated and performed in accordance with disclosed embodiments.

In other aspects, the disclosed embodiments may be configured to perform processes that monitor the income deposited into the investment account following the shortfall payment process (e.g., after the line of credit account was used to cover the shortfall), to determine when additional income has been generated for the investment account. Based on one or more configurations, the disclosed embodiments may be configured to perform processes that transfer all or a portion of the newly generated income to the credit facility or similar account that was used to cover the shortfall. The transfer of the income may cover all or a portion of the outstanding balance of the credit facility or similar account, which may include interest amounts applied to that account.

In certain aspects, the disclosed embodiments improve an operation and functionality of existing systems of financial institutions by reducing an amount of processing power required to execute scheduled funds transfers between an investment account held by user 110, which may generate periodic income, and a destination account associated with user 110, which may be configured to receive portions of that income. For instance, as described above, existing financial-institution systems may perform operations to execute automatically a scheduled funds transfer from the investment account, and may encounter an error condition related to an insufficient amount of funds in the investment account to perform the scheduled funds transfer, i.e., a shortfall. In certain aspects, existing financial-institution systems may log the error event in a data repository, and may perform additional processes that execute one or more overdraft protection mechanisms, and additionally or alternatively, perform additional operations cancel the scheduled funds transfer and/or linked funds transfers (e.g., by modifying a corresponding portion of memory stored data indicative of the scheduled funds transfer and/or the linked transfer), and generate and transmit notifications to a customer of the shortfall. These processes, when executed by existing financial-institution systems, increase an amount of computational and processing power necessary to execute a single scheduled funds transfer, and require substantial customer intervention, through interfaces presented by customer devices in communication with the financial-institution systems

The disclosed embodiments solve these and other problems encountered by existing financial-institution systems in a technical manner by, for example, providing computer-implemented systems and method that automatically modify portions of tangible storage devices to establish data structures associated with pre-approved credit facilities (e.g., without customer intervention) that, upon detection of the shortfall, may be linked corresponding shortfall account data stored within the tangible storage. In some aspects, as described below, one or more processors of a computer system or server may modify data stored within the tangible storage devices to implement a funds transfer of a portion of an amount associated with the scheduled funds transfer from the source account to the destination account, and further, a funds transfer of remaining portion of the scheduled funds transfer amount from the corresponding shortfall account to the destination account, without requiring customer intervention. In some embodiments, automatic funds transfer processes and shortfall event processes consistent with the disclosed embodiments may reduce a number of discrete operations required to perform the scheduled funds transfer, thus reducing the computational and processing power of the financial-institution systems required to implement the scheduled funds transfer.

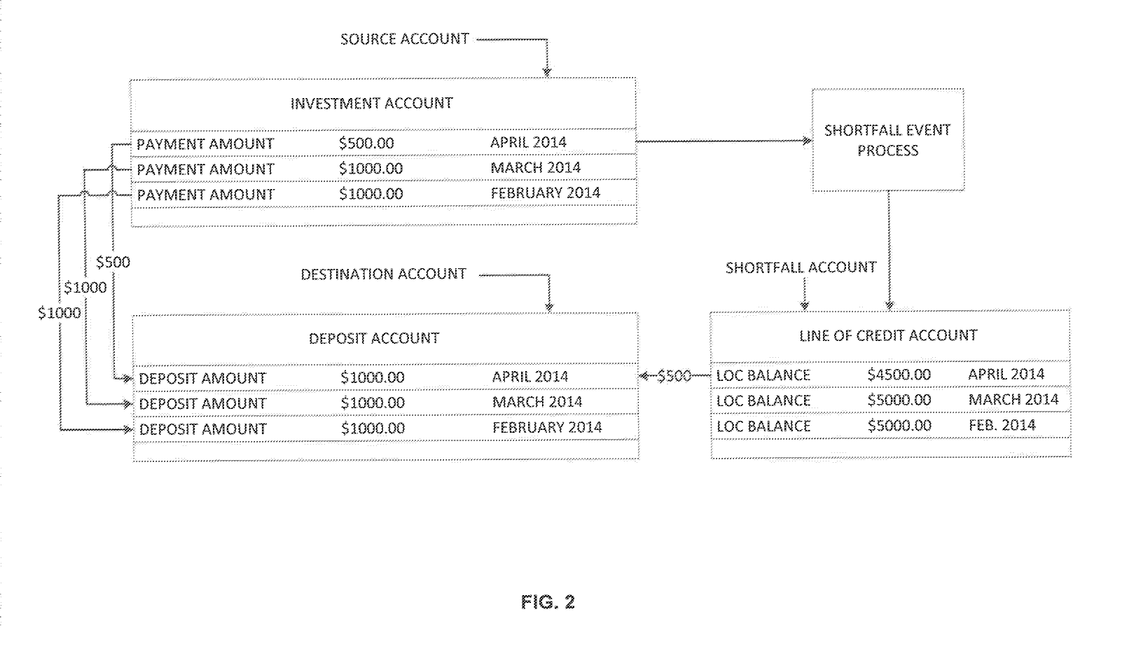

FIG. 2 shows a block diagram associated with processes and data structures consistent with certain shortfall fund transfer aspects of the disclosed embodiments. In one aspect, the disclosed embodiments may maintain data structures that include information relating to one or more accounts associated with user 110. For instance, system 131 may store such data structures in database 134 and generate information and store data relating to that information, in the data structures. As an example, FIG. 2 shows three exemplary data structures relating to a source account, a destination account, and a shortfall account. The source account may be an investment account held by user 110 and provided by business entity 130 (although not required), similar to that described above. The destination account may be a deposit account (e.g., a checking or savings account, etc.) held by user 110 and provided by business entity 130 (although not required).

The shortfall account may be a credit facility, such as a line of credit account requested by user 110 and approved and provided by business entity 130 (although not required). In accordance with disclosed embodiments, the line of credit account may be an account that has been secured based on the anticipated income generated by investments associated with the investment account. The disclosed embodiments are, however, not limited to credit facilities that include lines of credit secured against anticipated income derived from an investment account, and in other embodiments, the credit facility may include any additional or alternate borrowing facility provided by a financial institution or non-financial entity, as described above.

In this example, the investment account may provide periodic income on a monthly basis that is deposited into the investment account (source account). In the example of FIG. 2, $1000.00 may be deposited into the investment account in February and March. However, in April, the investment account may have experienced a shortfall event, and only received $500.00, result in a $500.00 shortfall in the anticipated investment account deposit.

In this example, the disclosed embodiments may execute software processes that perform automated deposit transactions from the investment account (source account) to the deposit account (destination account). As shown in FIG. 2, a deposit amount may be transferred from the investment account to the deposit account each month (e.g., $1000.00 in February and March, and $500.00 in April).

The disclosed embodiments may be configured to execute software that performs a shortfall event process that may determine whether the shortfall account should be used to make up for the $500.00 shortfall. In one embodiment, the shortfall event process may include operations that determine a shortfall event based on the payment amount in the investment account in April 2014. For example, in response to determining the shortfall event, the shortfall event process may include triggering a fund transfer from the line of credit account in the amount of the determined shortfall (e.g., $500.00) in the investment account. The fund transfer may result in a transfer of the shortfall amount (e.g., $500.00) from the line of credit account (shortfall account) to the deposit account (destination account). As such, the deposit account may still receive the $1000.00 that may, in this example, be routinely deposited into that account.

In other aspects, the disclosed embodiments may execute the shortfall event process such that it determines a shortfall event based on another account different from the investment account, or in addition to the payment amount to the investment account. For example, the disclosed embodiments may determine a shortfall event based on the amount transferred into the destination account (deposit account). Thus, in one example, based on configured rule(s) and conditions that may configured by user 110 and/or system 131, the disclosed embodiments may determine a shortfall event when the amount deposited into the deposit account is below a determine threshold (e.g., below $1000.00, below a certain portion of a determine amount (e.g., 5% below $1000.00, etc.)). The disclosed embodiments may also determine a shortfall event based on the account balance of an account (e.g., deposit account, investment account, etc.). In other aspects, the disclosed embodiments may determine a shortfall event based on whether the deposit account has sufficient funds to cover an automated scheduled funds transfer from that account to another accounts, such as a billing account (e.g., mortgage account, utility service account, credit card account, etc.). Thus, in one example, user 110 may have configured an automated funds transfer to occur periodically from deposit account (e.g., checking account) to a bill account. In this example, the disclosed embodiments may determine a shortfall event based on the balance of the deposit account or the deposit amount to that account, in anticipation of the shortfall of a payment to the billing account. For instance, if user 110 has a mortgage account of $1000.00, the disclosed embodiments may perform processes that recognize a shortfall to the billing account based on an initial deposit amount of $500.00 from the investment account (or some other type of source account). In response, the disclosed embodiments may perform the shortfall event process such that the secured line of credit account (secured based on the investment account), is leveraged to provide the shortfall amount ($500.00) to the deposit account to cover the anticipated mortgage payment of $1000.00.

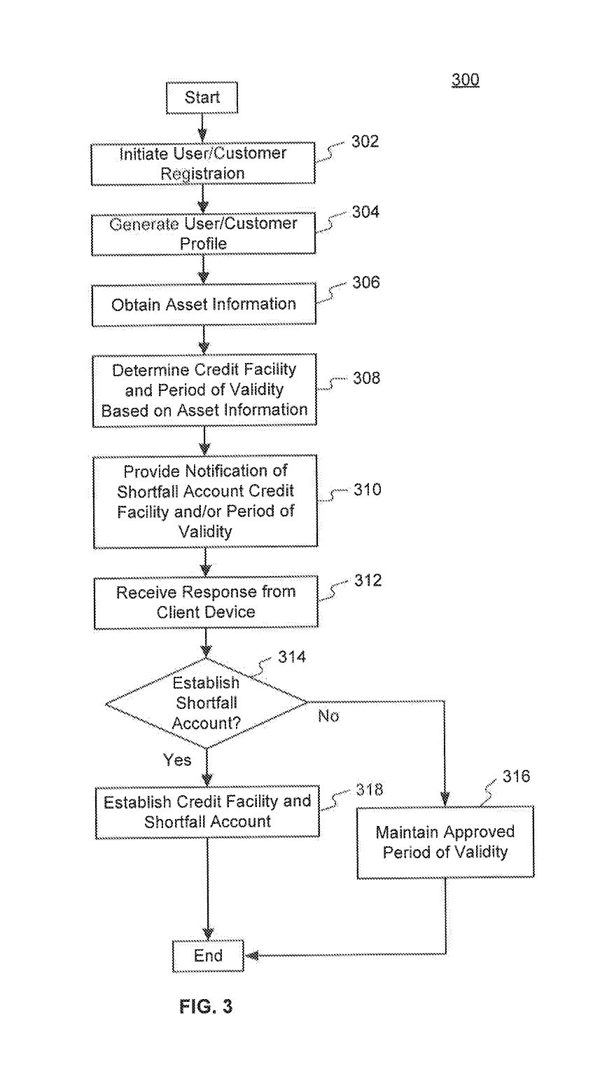

Examples of processes and related components of systems consistent with these and other disclosed embodiments are disclosed herein. For example, FIG. 3 illustrates an exemplary registration process 300, consistent with disclosed embodiments.

The disclosed embodiments may perform one or more operations of registration process 300 to register (e.g., opt-in) a user (e.g., user 110) to participate in shortfall service(s) provided by an entity (e.g., business entity 130 or other entity) based on an investment account of user 110. For example, user 110 may have a brokerage account with business entity 130. User 110 may further own various financial instruments in the brokerage account. For example, user 110 may own shares of different commonly traded stocks. In other embodiments, an investment account may include money in a money market account, bond holdings with different maturity dates (e.g., corporate bonds, government bonds, municipal bonds, etc.), mutual funds, commodities, and exchange traded funds (ETFs).

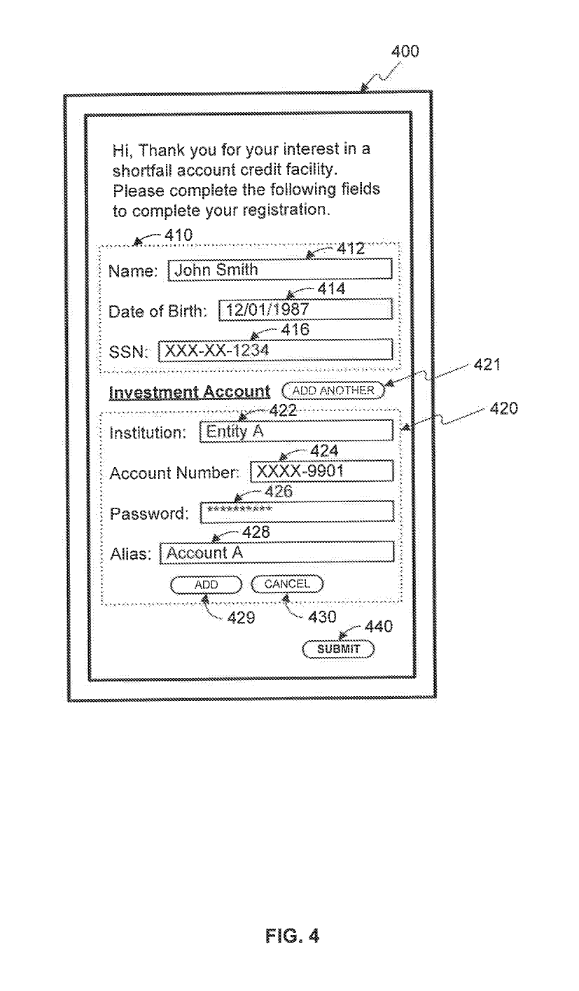

In certain aspects, system 131 may be configured to perform one or more operations of process 300. For instance, at step 302, server 132 may initiate user registration. Registration initiation may be performed responsive to a user inquiry or an automatic solicitation of a user, such as an advertisement or other communication relating to the shortfall service. In one aspect, client device 102 may be configured to receive input from user 110 relating to a user registration and transmit information corresponding to the input to server 132. In one example, client device 102 may be configured to receive information from system 131 to generate and display an interface on a display device of client device 102 to allow user 110 to input user registration information. FIG. 4 is an exemplary customer registration interface 400 that requests user registration information from a user, such as user information 410 and investment account information 420, consistent with disclosed embodiments.

In one example, user information 410 may include user name field 412, date-of-birth field 414, and social security number (or other user identification) field 416. User information 410 may include different and/or additional fields to receive more information about the user, such as mailing address, phone number, and email address, for example.

In some embodiments, system 131 may perform processes that provide, to client device 102, data that allows client device 102 to pre-fill one or more of the fields of user information 410 (e.g., name field 412, date-of-birth field 414, and/or social security number field 416). By way of example, the data provided to client device 102 may include, but is not limited to, on information known about the user from another account or user information stored in database 134. In other aspects, client device 102 may access locally stored data to prefill one or more of the fields of user information 410, with or without data provided by system 131. Further, where information from system 131 or client device 102 is not available, user 110 may enter the required data about themselves in these fields via client device 102. Some of the fields may be optional while others may be required.

Investment account information 420 may identify a particular investment account of user 110. Server 132 may, for example, use investment account information 410, when received via client device 102, to determine one or more investment holdings of user 110. Investment account information 410 may include institution field 422, account number field 424, password field 426, and alias field 428. Different or additional fields may be used to identify and access a particular investment account associated with user 110. Institution field 422 may represent an entity that holds and manages the identified investment account. Account number field 424 may represent the identification code of the investment account. Password field 426 may be the password required to access the investment account and view the holdings. In certain embodiments, the information of password field 426 may allow server 132 to make changes to the holdings of the investment account. Alias field 428 may represent the label of the account that user 110 wishes to appear to identify the account.

In some embodiments, system 131 may perform processes that provide, to client device 102, data that allows client device 102 to pre-fill one or more of the fields of investment account information 420 (e.g., institution field 422, account number field 424, password field 426, and/or alias field 428). For example, and as described above, the data provided to client device 102 may include, but is not limited to, information known about the user investment accounts from another account or user information stored in database 134. In other aspects, client device 102 may access locally stored data to prefill one or more of the fields with or without data provided by system 131. Further, where information is not available, user 110 may enter the required account information data via client device 102. As described herein, some of the fields of account information 420 may be optional, while others may be required.

When the required fields of investment account information 420 are complete, the user may submit the information to server 132 via client device 102 by clicking, pressing, or otherwise selecting “add” region 429 of interface 400. Further, in some instances, clicking, pressing, or otherwise selecting “cancel” region 430 of interface 400 may cause client device 102 to clear the data entered into the fields of investment account information 420.

User 110 may use client device 102 to add additional investment accounts to customer registration interface 400 by clicking, pressing, or otherwise selecting “add-another” region 421. Client device 102 and/or system 131 may, in response to receiving input relating to region 421, generate and provide additional set of investment account information 420 in interface 400 for user 110 to enter one or more additional investment accounts. When user 110 is satisfied with the information in the fields of user registration interface 400, user 110 may click, press, or otherwise select “submit” region 440 to cause client device 102 to transmit the user registration information from client device 102 to server 132.

In certain embodiments, server 132 may receive and store the user registration information provided by client device 102 in a memory (e.g., database 134). Server 132 may be configured to generate a user profile based on the received user registration information (e.g., in step 304).

In one aspect, server 132 may obtain assert information (e.g., in step 306). For example, server 132 may obtain information on the assets of the user's investment account based on the user registration information provided by client device 102. For example, server 132 may use the credentials provided in the user information 410 to access an investment account to obtain information regarding assets relating to the user's investment account. For instance, server 132 may identify the value, types, and other characteristics of the investment account, such as stocks, GICs, mutual funds, number of shares, etc. Further information regarding the holdings of the investment account may be obtained as needed to evaluate the user's investment account.

Server 132 may be configured to determine and create a shortfall account for user 110 based on the analysis of the user's investment account. In one embodiment, a shortfall account may reflect an account that provides a credit facility or similar type of account that may be used to fund transactions. For example, the user's shortfall account may be a credit facility (e.g., a line of credit) that is created based on the value of the user's investment account(s). Server 132 may execute software instructions that perform processes that determine an amount of credit provided by the credit facility (e.g., a credit line) for the user's shortfall account that is secured against one or more user investment accounts. In the exemplary process 300, In one aspect, sever 132 may determine whether user 110 is pre-approved for a line of credit based on the holdings of one or more investment accounts and the amount for the line of credit (e.g., in step 308).

In another embodiment, in step 308, server 132 may determine a period for which the credit facility may be valid (e.g., a period of validity). For example, server 132 may execute software that performs processes to approve, create, and maintain the shortfall account (e.g., a line of credit) based on the holdings of the investment account and information about the user. For example, server 132 may consider the amount, type, volatility, and liquidity of the investment holdings associated with an investment account to determine an amount of credit provided by the credit facility (e.g., the line of credit) and the period of validity. In some instances, the period of validity may be shorter for an amount of common stock of the user's investment account compared with the period of validity for a money market account associated with the same amount. In additional instances, server 132 may establish a lower credit amount for the credit facility (e.g., a lower line of credit) and/or a shorter period of validity if user 110 has low credit rating, a history of inconsistent employment, etc. For example, if user 110 is unemployed, has a low credit rating, and has an investment account that consists of highly volatile common stock, server 132 may determine and establish a credit line with a lower line of credit as opposed to if user 110 is a tenured employee having a high credit score and an investment account with significant money market holdings. Additional factors and considerations known in the art may be used by server 132 in determining the parameters of the user's shortfall account and period of validity. In some aspects, server 132 may determine to reassess the determined period of validity of the credit facility at regular or periodic intervals (e.g., monthly, quarterly, etc.), in response to specific market events (e.g., large swings in stock indices), and/or in response to specific actions by user 110 (e.g., a modification to the holdings in the investment account, etc.).

Further, in some aspects, a pre-approved, but unused, credit facility (e.g., a credit line) may not impact a credit history of user 110. For example, server 132 may delay reporting an existence of a pre-approved, but unused credit line to various credit bureaus (e.g., Transunion™ and Experian™) until user 110 or system 131 access the credit line to cover an initial shortfall (e.g., during an initial transfer from the shortfall account). Thus, in some embodiments, a “credit worthiness” of user 110 may not be impacted by the pre-approval of a credit facility, such as a line of credit, to cover an anticipated, but not yet realized, shortfall.

In one embodiment, server 132 may generate and provide a notification of the established credit facility (e.g., a line of credit established based on a value of the user's investment account(s), as described above) to client device 102 (e.g., in step 310). In certain aspects, server 132 may provide the notification to client device 102 such that client device 102 generates and displays the notification on a display device, such as, for example, via a mobile application, email, text message, etc. The notification may include information that identifies the amount of credit available and the period of validity. The notification may also solicit a response from the user indicating whether or not user 110 wishes to establish the shortfall account for the pre-approved credit facility (e.g., the line of credit). User 110 may provide a response via client device 102, which provides the user response information to system 131.

At step 312, server 132 may receive the user's response from client device 102. The response may include an indication of whether or not user 110 wishes to establish the shortfall account with the pre-approved credit facility.

At step 314, server 132 may determine whether or not to establish the pre-approved credit facility. This determination may be made based on a message from user 110 sent in response to a notification of pre-approval. The lack of a response may indicate that the credit line should not be established.

If the credit facility were not established (e.g., step 314; No), at step 316, server 132 may maintain the pre-approval amount for the period of validity. This may further allow user 110 to later establish the credit facility when a shortfall is imminent, while preventing a reporting of the credit facility extended on and secured by the investment account. Server 132 may perform processes that reevaluate the shortfall account parameters (e.g., credit line) based on any subsequent changes to the user's investment account(s). For example, server 132 may execute the approval processes should the holdings of the investment account change. For example, if a user sells a stock holding and distributes the liquidation from the investment account, the material holdings of the investment account are altered, and an amount of credit provided by the credit facility (e.g., the credit line) may be reduced. Further, the period of validity may be reduced or removed entirely due to increased volatility of holdings or a decrease in market valuation. For example, if the investment account includes an ETF that is based on the currency of a foreign nation and that nation enters civil unrest, the period of validity may end. Exemplary process 300 is then complete.

If, however, server 132 determines that the credit facility is to be established (e.g., step 314; Yes), at step 318, server 132 may establish the credit facility for user 110 and establish an available balance in a corresponding shortfall account (e.g., based on an amount of available credit provided by the credit facility). In certain aspects, server 132 may establish the credit facility, such as a line of credit, in accordance with one or more credit approval processes (e.g., “normal” processes) associated with the financial institution, and the established line of credit may be backed by forms of collateral consistent with the credit approval processes and deemed appropriate by the financial institution. The established shortfall account may be subject to a period of validity, and that period of validity may be shortened or ended as discussed above. In certain embodiments, however, the credit facility (e.g., the line of credit) may not be subject to a period of validity. In some aspects, upon establishment of the available balance within the shortfall account, user 110 and/or server 132 may access funds within the shortfall account, and the shortfall account may be ready for use in funds transfers, as described below. Further, in step 318, server 132 may execute software instructions that update stored information (e.g., database 134) to allow the shortfall account to be used when needed in accordance with disclosed embodiments. Upon establishment of the credit facility and shortfall account, exemplary process 300 is complete.

In certain aspects, one or more exemplary techniques described above enable server 132 to pre-approve a line of credit for user 110 based on amounts, types, volatilities, and liquidities of investment holdings associated with user 110's investment account or accounts), to maintain the pre-approved credit line for a determined period of validity, and additionally or alternatively, to establish a shortfall account for user 110 based on the pre-approved credit line. The disclosed embodiments are, however, not limited to lines of credit secured against one or more of user 110's investment holdings. In further embodiments, one or more of the exemplary techniques described above may enable server 142 to pre-approve any additional or alternate credit facility for user 110 (e.g., based on amounts, types, volatilities, and liquidities of user 110's investment holdings), to maintain the pre-approved status of the credit facility for a determined period of validity, and/or to establish user 110's shortfall account based on the pre-approved credit facility. In some aspects, as described above, credit facilities consistent with the disclosed embodiments may include, but are not limited to loans, demand products, overdraft protection services, and/or borrowing facilities provided to user 110 by financial institutions and similar entities. Further, additional credit and/or borrowing facilities consistent with the disclosed embodiments may include, but are not limited to funds borrowed from family members or close friends, funds obtained from crowdsourcing and other sources of syndicated investment funds, funds borrowed from micro-financing entities, and/or other credit facilities provided by non-financial entities, as described above.

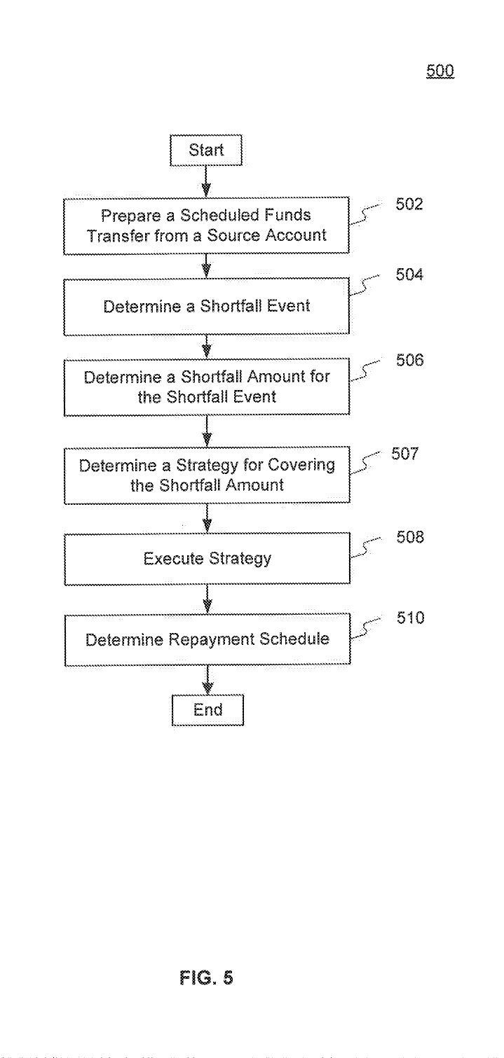

FIG. 5 illustrates an exemplary financial account provisioning and repayment process 500, consistent with disclosed embodiments. In certain embodiments, server 132 (or other component of system 131) may be configured to perform one or more operations of process 500.

In one embodiment, in step 502, server 132 may prepare a scheduled funds transfer for user 110. In certain aspects, a scheduled funds transfer may be an operation performed by server 132 that automatically performs a transfer transaction between a source account and one or more destination accounts (e.g., one or more of the exemplary transfer transactions involving source and destination accounts described above).

In certain embodiments, prior to the scheduled transfer, server 132 may monitor the account balance of the source account (e.g., periodically, etc.). Additionally or alternatively, server 132 may be configured to check the source account balance at a predetermined time in advance of the scheduled funds transfer. For example, server 132 may check the balance of an investment account of user 110 each hour leading up to a $1000.00 payment that is scheduled to be transferred to a deposit account associated with the user, as described above.

The source account may be any type financial account held by user 110 (e.g., a checking account, a savings account, a money market account (MMA), investment account associated with investment portfolio, etc.). The destination account may be, for example, an account of user 110 (e.g., a savings or checking account), another user's account (e.g., the checking account of another user), and/or a business account (e.g., a power company account, a credit card company account, etc.). The scheduled transfer may be recurring (e.g., weekly, monthly, annually, etc.) or may represent a one-time transfer. For example, user 110 may establish, via client device 102 and system 131, recurring payments from a checking account to the checking account of a landlord for rent on the first day of each month. As another example, the scheduled transfer may be associated with a monthly payment from a parent's checking account to a deposit account of their child for an allowance.

At step 504, server 132 may determine whether the scheduled finds transfer will result in a shortfall event. In one example, server 132 may determine a potential shortfall event based on an available balance in the source account (e.g., whether the available balance is sufficient to perform the scheduled funds transfer). Server 132 may also calculate the shortfall amount associated with the shortfall event (e.g., step 506). In one example, server 132 may use the information on the available funds in the source account and the amount of the schedule funds transfer to calculate the shortfall amount. For example, server 132 may determine the difference between the $500.00 available in the investment account of user 110 and the scheduled funds transfer for $1000.00. In that example, the shortfall amount would be $500.00, as described above. Alternatively, server 132 may determine that only $500.00 was transferred from the source account rather than $1000.00, and calculate the shortfall after the funds transfer below the scheduled amount.

At step 507, server 132 may determine a strategy that remedies the identified shortfall event and enables the funds transfer to proceed as scheduled. In some embodiments, server 132 may identify a shortfall account associated with a credit facility (e.g., a line-of-credit) established for user 110, and may determine whether an available balance associated with the shortfall account exceeds the shortfall amount. For example, and as described above, the line-of-credit may represent a pre-approved but unused line of credit established for user 110, or server 132 may have previously tapped user 110's line-of-credit to cover a prior shortfall. In certain aspects, when the shortfall account balance exceeds the shortfall amount, the determined strategy may include a funds transfer in the shortfall amount from the shortfall account to the source account. In other aspects, the amount of the funds transfer from the shortfall account may represent a predetermined multiple of the shortfall amount (e.g., 110% of the shortfall amount), which server 132 may compute based on pre-established condition(s), designations that user 110 made during the registration process 300, or other factor(s).

In other embodiments, and as an alternative to or in addition to a funds transfer from the shortfall account, the determined strategy may also include a liquidation of assets held by user 110 in corresponding investment accounts. For example, the available funds in the shortfall account may cover only a portion of the anticipated shortfall amount, and server 132 may determine in step 507 that one or more the assets held by user 110 may be liquidated to cover the remaining portion of the shortfall amount. Additionally or alternatively, server 132 may determine that a funds transfer from the shortfall account may result in a substantial future obligation to user 110 (e.g., due to a high interest rate from the line-of-credit associated with the shortfall account), and server 132 may determine in step 507 that the liquidation of assets held by user 110 may generate cash to cover all or a portion of the anticipated shortfall amount without the substantial future obligation associated with the shortfall account.

For example, and as described above, the source accounts may hold positions in financial instruments that may be easily liquidated, but incur a cash or tax penalty upon liquidation (e.g., securities held within a retirement plan, or investments that would yield short-term capital gains upon liquidation). In some aspects, server 132 may determine whether to liquidate at least a portion of these positions based on a comparison of an interest rate and the cash or tax penalty that would be incurred upon liquidation of these financial instruments.

In some aspects, server 132 may determine that an established shortfall account may be funded by a credit facility charging an interest rate of 7%. Further, in some instances, the source account may include positions in financial instruments that may be easily liquidated, but incur a 5% cash penalty upon liquidation. In some aspects, in step 507, server 132 may determine that the 5% cash penalty resulting from the liquidation of these positions may be more advantageous to user 110 than transferring funds of a comparable amount from the shortfall account at the 7% interest rate. Server 132 may, in certain instances, determine in step 507 that the positions in the financial instruments associated with the 5% cash penalty be liquidated prior to accessing funds in the shortfall account at the 7% interest rate.

The disclosed embodiments are, however, not limited to processes that balance an interest rate associated with a credit facility against liquidation penalties associated with assets held by user 110 within the source account. In other aspects, server 132 may determine in step 507 whether to liquidate assets held by user 110 based on fees associated with the held assets (e.g., brokerage fees, service fees, and/or other fees associated with operations performed by server 132 to liquidate the assets), fees associated with fund transfers from the shortfall account (e.g., service fees, etc.), and/or other financial considerations impacting user 110 (e.g., an impact of a funds transfer from the shortfall account on user 110's credit score, interest rates charged by other secured and unsecured debt instruments (e.g., credit cards, revolving credit lines) held by user 110, etc.).

Server 132 may identify one or more of the assets held by user 110 for liquidation in step 507 based on, for example, liquidity characteristics of the assets, penalties associated with liquidating the assets, and/or preferences of user 110 and business entity 130. In certain aspects, the source account may receive investment income derived from positions held in a variety of financial instruments, which may be associated with varying degrees of liquidity. For example, user 110 may receive interest income from financial instruments that may be readily liquidated and converted to cash (e.g., a money market account (MMA) or shares in common stocks traded on a public exchange). Additionally or alternatively, user 110 may receive investment income from other financial instruments and/or investment products that may not be readily liquidated and converted to cash (e.g., bonds having specified maturity dates, GICs of specified term, stock in privately held companies, and/or real estate holdings). Further, in some instances, user 110 may hold positions in financial instruments that may be easily liquidated, but incur a cash or tax penalty upon liquidation (e.g., securities held within a retirement plan, or investments that would yield short-term capital gains upon liquidation).

Additionally, user 110 may specify preferences regarding the liquidation of assets within the strategy determined by server 132. In certain aspects, user 110 may specify (e.g., through a corresponding interface presented by client device 102) that particular assets or positions in financial instruments should be liquidated before other assets or positions, and further, that one or more assets or positions in financial instruments should not be liquidated to cover an anticipated shortfall event. For example, user 110 may specify that one or more money market accounts (MMAs) should be liquidated before shares in certain common stock, which should be liquidated prior to holdings in one or more bonds. Further, in some instances, user 110 may specify that the determined strategy should not liquidate certain assets (e.g., shares in preferred stock, etc.) when remedying the anticipated shortfall event.

In other aspects, the user preferences may also specify a desired level of interaction between user 110 and server 132 during the generation and subsequent implementation of the strategy for remedying the anticipated shortfall. By way of example, user 110 may request that server 132 perform operations to liquidate one or more assets upon receipt of a confirmation from user 110 (e.g., through client device 102). Further, user 110 may also express, through a corresponding interface presented by client device 102, a preference that assets should not be liquidated when a rate of return on the asset exceeds a penalty associated with the anticipated shortfall event, that common stocks receiving dividends should not be liquidated, and/or that bonds may be liquidated immediately upon reaching maturity.

In some embodiments, the determined strategy may also include delaying a scheduled funds transfer for a pre-determined or adaptively determined time. For example, user 110 may hold shares of a common stock expected to pay a dividend of $1,000 on May 31, 2014, into a corresponding source account (which currently holds a balance of $100). Further, using the exemplary processes described above, server 132 may identify a shortfall event resulting from a scheduled funds transfer of $1,000 from the source account on May 29, 2014, which might result in a shortfall amount of $900.

In some instances, server 142 may delay the scheduled funds transfer until May 31^{st} to enable receipt of the dividend in the source account. Server 132 may, in some instances, determine that a penalty associated with the delayed funds transfer does not exceed a cost incurred by user 110, or income lost to user 110, when server 132 performs processes to liquidate assets to cover the shortfall amount. For example, the scheduled funds transfer may pay rent for user 110, and a late fee of $50 incurred to delay the scheduled funds transfer may be less than the expected interest on assets that would be liquidated to cover the shortfall amount.

In the embodiments described above, server 132 may determine, in step 507, a strategy for covering an anticipated shortfall resulting from a scheduled funds transfer from the source account based on, among other things, an availability of funds within a shortfall account associated with a line-of-credit extended to user 110, liquidity characteristics of assets held by user 110, preferences of user 110 or business entity 130, and/or anticipated deposits into the source account (e.g., expected dividends, etc.) The determined strategy, may, for example, enable server 132 to cover the anticipated shortfall event and perform the scheduled funds transfer, while reducing current and future costs to user 110 and maintaining an acceptable level of return on one or more assets that fund the source account.

Referring back to FIG. 5, at step 508, server 132 (or another component of system 131) may generate one or more electronic instructions to implement the determined strategy to remedy the shortfall. In one example, server 132 may perform a funds transfer from the user's shortfall account, which may be a credit facility (e.g. a line of credit and/or other borrowing facilities provided by financial and non-financial entities), to the destination account. Alternatively, server 132 may perform a funds transfer from a shortfall account to the source account that is subject to the shortfall in advance of the scheduled funds transfer. The funds transfer may be for the shortfall amount. In other instances, either alone or in combination with a funds transfer from the shortfall account, server 132 may perform processes that liquidate one or more assets held by user 110 to generate cash to remedy the shortfall amount. Further, as described above, server 132 may also perform processes that delay the scheduled shortfall, e.g., in anticipation of income into the source account.

At step 510, server 132 may determine a repayment schedule by which user 110 repays the amount transferred from the shortfall account. In one embodiment, server 132 may perform repayment schedule processes to determine a repayment amount schedule (e.g., one time repayment amount, periodic repayment amounts, etc.), a repayment time period (e.g., one time repayment, periodic repayment dates, etc. In certain aspects, server 132 may assess subsequent scheduled funds transfers in determining the repayment schedule. The repayment plan may include interest on the shortfall amount transferred from the shortfall account. Server 132 may also determine the repayment source account for providing the repayment amount(s) consistent with the determined repayment schedule. For example, server 132 may determine that the repayment amount be taken from the source account. In other embodiments, the repayment plan may receive payments from other account(s). In still other embodiments, the repayment amount(s) may be collected from the account of another user, such as a relative, friend, or business that may be tied to user 110. Server 132 may be configured to perform processes that determine the repayment source account based on preconfigured condition(s) or condition(s) established by user 110 during the registration process 300. Upon determination of the repayment schedule, exemplary process 500 is complete.

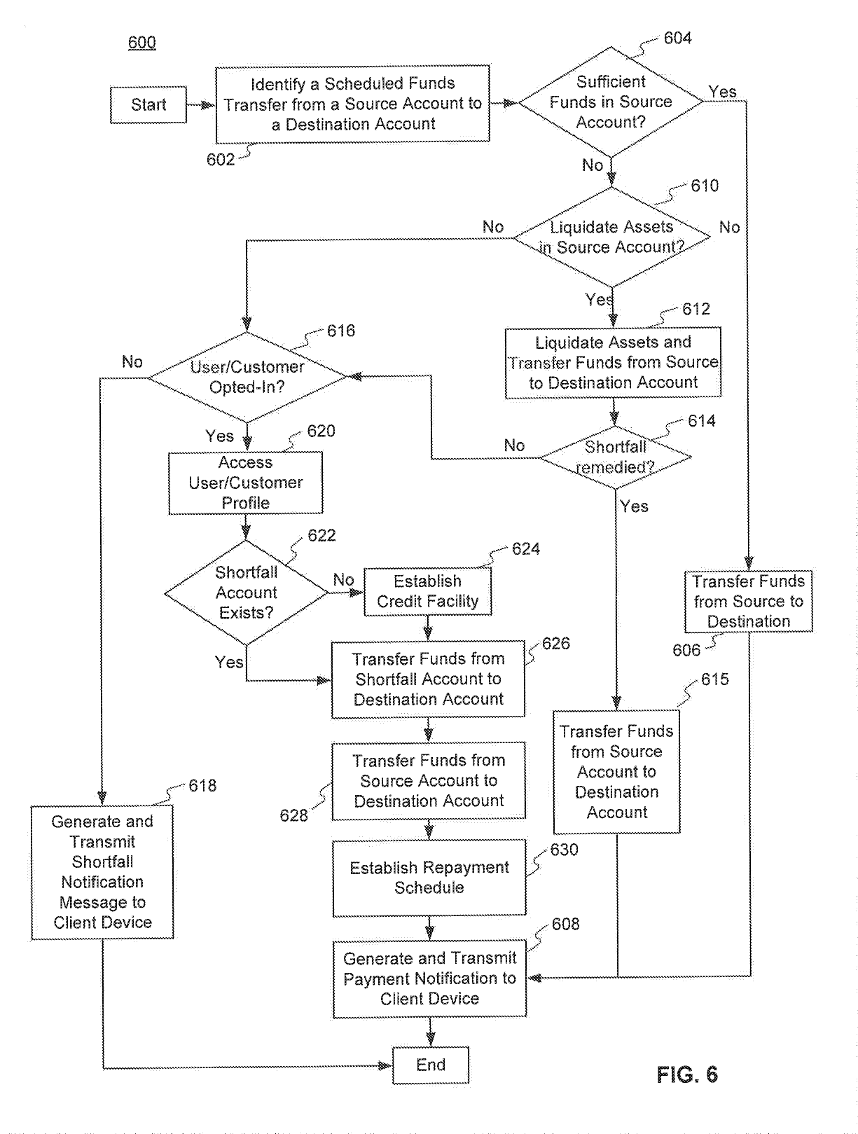

FIG. 6 illustrates an exemplary financial account provisioning and repayment process 600, consistent with disclosed embodiments. In certain embodiments, server 132 may be configured to perform one or more operations of process 600.

In one embodiment, in step 602, server 132 may identify a scheduled funds transfer for user 110. A scheduled funds transfer may be an operation performed by server 132 that automatically performs a transfer transaction between a source account and one or more destination accounts. At a time prior to the transfer, server 132 may monitor the account balance of the source account for the transfer (e.g., periodically, etc.). Alternatively, server 132 may be configured to check the source account balance at a predetermined time in advance of the scheduled transfer. For example, server 132 may monitor the balance of a checking account of user 110 the day before a $1000.00 rent payment is scheduled to be transferred to an account associated with the user's landlord.

The source account may be any type financial account of user 110 (e.g., a checking account, investment account associated with investment portfolio, etc.). The destination account may be, for example, an account of user 110 (e.g., a savings or checking account), another user's account (e.g., the checking account of another user), a business account (e.g., a power company account, a credit card company account, etc.). The scheduled transfer may be recurring (e.g., weekly, monthly, annually, etc.) or may represent a one-time transfer. For example, user 110 may establish recurring payments from a checking account to the checking account of a landlord for rent on the first day of each month. As another example, similar to that described above, the scheduled transfer may be associated with a reoccurring deposit from an investment account to the user 110's deposit account.

At step 604, server 132 may determine whether an available balance in the source account is sufficient to support the scheduled transfer. For example, server 132 may execute software instructions that perform a process to determine whether the source account balance above a certain amount to trigger the funds transfer to a destination account. In other embodiments, other scheduled transfers may be taken into account. In other, embodiments, server 132 may be configured to perform processes that determine whether the source account balance is below a buffer amount that the account should not drop below. For example, server 132 may determine that while there is $1000.00 in the checking account of user 110, server 132 may determine that there are insufficient funds in the account based on an account parameter that requires that at least $2000.00 be in the account at all times, which may be configured by user 110 via system 131.

If there are sufficient funds in the source account (e.g., step 604; Yes), server 132 may perform processes that cause an automated funds transfer transaction to occur from the source account to the destination account (e.g., in step 606), and in certain aspects, server 132 may generate and transmit a notification message to client device 102 (e.g., in step 608). In some instances, server 132 may generate and provide the notification (e.g., in step 608) following a successful transfer of funds from the source account to the destination account (e.g., which occurred in step 606). For example, server 132 may generate and provide the notification in a message via email, text message, etc. based on pre-established condition(s) programmed for server 132, the preferences of user 110, etc. Exemplary process 600 is then complete.

If, however, server 132 determines that the source account includes insufficient funds (e.g., step 604; No), the scheduled transfer may result in a shortfall in the source account, and system 132 may determine whether to liquidate one or more assets held within the source account in order to increase the available balance in the source account and cover at least a portion of the anticipated shortfall (e.g., in step 610).

By way of example, and as described above, the source account may receive investment income derived from positions held in a variety of financial instruments, which may be associated with varying degrees of liquidity, and further, which may incur a tax or cash penalty due to untimely or unscheduled liquidation. For instance, the source account may include positions in financial instruments that may be readily liquidated and converted to cash (e.g., a money market account (MMA) or shares in common stocks traded on a public exchange), and additionally or alternatively, positions in financial instruments and investment products that may not be readily liquidated and converted to cash (e.g., bonds having specified maturity dates, GICs of specified term, stock in privately held companies, and/or real estate holdings). Further, in some instances, the source account may include positions in financial instruments that may be easily liquidated, but incur a cash or tax penalty upon liquidation (e.g., securities held within a retirement plan, or investments that would yield short-term capital gains upon liquidation).

Further, for example, user 110 and/or business entity 130 may specify preferences regarding the liquidation of assets held by user 110 within the source account. In some instances, as described above, user 110 and/or business entity may establish preferences (e.g., within corresponding profile data generated during user 110's initial registration for shortfall services and/or digital banking services) that particular assets or positions in financial instruments should be liquidated before other assets or positions, and further, that one or more assets or positions in financial instruments should not be liquidated to cover an anticipated shortfall event. For example, user 110 and/or business entity 130 may specify that one or more money market accounts (MMAs) should be liquidated before shares in certain common stock, which should be liquidated prior to holdings in one or more bonds. Further, in some instances, user 110 may specify that the determined strategy should not liquidate certain assets (e.g., shares in preferred stock, etc.) when remedying the anticipated shortfall event.

Additionally or alternatively, server 132 may determine whether to liquidate one or more assets held within of the source account (e.g., in step 610) based on an interest rate associated with a credit facility that funds the shortfall account. For example, and as described above, the source account may hold positions in financial instruments that may be easily liquidated, but incur a cash or tax penalty upon liquidation (e.g., securities held within a retirement plan, or investments that would yield short-term capital gains upon liquidation). In some aspects, server 132 may determine whether to liquidate at least a portion of these positions based on a comparison of the interest rate and the cash or tax penalty that would be incurred upon liquidation of these financial instruments.

By way of example, server 132 may determine that an established shortfall account may be funded by a credit facility charging an interest rate of 7%. Further, in some instances, the source account (e.g., held by user 110, by the additional user, and/or jointly by user 110) may include positions in financial instruments that may be easily liquidated, but incur a 5% cash penalty upon liquidation. In some aspects, in step 610, server 132 may determine that the 5% cash penalty resulting from the liquidation of these positions may be more advantageous to user 110 than transferring funds of a comparable amount from the shortfall account at the 7% interest rate. Server 132 may, in certain instances, determine in step 610 that the positions in the financial instruments associated with the 5% cash penalty be liquidated prior to accessing funds in the shortfall account at the 7% interest rate.

The disclosed embodiments are, however, not limited to processes that balance an interest rate associated with a credit facility against liquidation penalties associated with assets held by user 110 within the source account. In other aspects, server 132 may determine in step 610 whether to liquidate assets held by user 110 based on fees associated with the held assets (e.g., brokerage fees, service fees, and/or other fees associated with operations performed by server 132 to liquidate the assets), fees associated with fund transfers from the shortfall account (e.g., service fees, etc.), and/or other financial considerations impacting user 110 (e.g., an impact of a funds transfer from the shortfall account on user 110's credit score, interest rates charged by other secured and unsecured debt instruments (e.g., credit cards, revolving credit lines) held by user 110, etc.).

In some aspects, based on the liquidity characteristics of the assets, penalties associated with liquidating the assets, and/or preferences of user 110 and business entity 130, server 132 may determine in step 610 whether to liquidate all or a portion of the assets held within the source account to address the anticipated shortfall. If server 132 were to determine that at least a portion of the assets within the source account should be liquidated (e.g., step 610; Yes), server 132 may perform operations to liquidate the portions of the assets (e.g., automatically or in response to confirmation received from user 110 through client device 102) to generate cash, which server 132 may transfer from the source account to the destination account using any of the techniques described above (e.g., in step 612). For example, server 132 may identify that the source account includes positions in a money market account (MMA), and may determine in step 610 that user 110's positions in the MMA should be sold and converted to cash. As described above, server 132 may be configured in step 612 to transfer the generated cash from the source to the destination account.

In some aspects, server 132 may be configured to determine whether the cash resulting from the liquidated assets (e.g., as transferred by server 132 from the source account to the destination account) remedies the anticipated shortfall (e.g., in step 614). If server 132 determines that the cash resulting from the liquidated assets remedied the anticipated shortfall (e.g., step 614; Yes), server 132 may be configured in step 615 to transfer the generated cash from the at least one source account to the one or more destination accounts (e.g., as specified by the scheduled fund transfers identified by server 132, as described above). In certain aspects, exemplary process 600 may pass back to step 608, and server 132 may generate and transmit, to client device 102, a notification message identifying the liquidated assets and the transferred funds using any of the exemplary techniques outlined above. Exemplary process 600 is then complete.

If, however, the cash generated through the liquidation of the assets is insufficient to remedy the anticipated shortfall (e.g., step 604; No), server 132 may determine whether the user has opted-in to participate in the shortfall event processes consistent with the disclosed embodiments (e.g., in step 616). For example, system 132 may determine that the cash resulting from the liquidation of user 110's MMA positions (e.g., as held within the source account) covered only a portion of the anticipated shortfall. In certain instances, server 132 may determine in step 616 whether user 110 opted-in to the shortfall event processes consistent with the disclosed embodiments that may provide funds to cover the remaining portion of the anticipated shortfall and facilitate the scheduled transfer.

Further, referring back to step 610, if server 132 determines that no portion of the assets within the source account should be liquidated to remedy the anticipated shortfall (e.g., step 610; No), server 132 may determine whether the user has opted-in to participate in the shortfall event processes consistent with the disclosed embodiments (e.g., in step 616). For example, server 132 may determine that the assets held within the source account are illiquid, and additionally or alternatively, that the liquidation of the assets would result in unacceptable tax or cash penalties (e.g., as established by preferences of user 110 and/or business entity 130). In some aspects, as described above, server 132 may determine in step 616 whether user 110 opted-in to shortfall event processes consistent with the disclosed embodiments, which may provide funds to cover the anticipated shortfall and facilitate the scheduled transfer.

As described above, in step 616, server 132 may determine whether the user has opted-in to participate in the shortfall event processes consistent with the disclosed embodiments. For example, server 132 may determine whether user 110 has registered with system 131 to participate in a shortfall event process, such that a shortfall account is used to cover any shortfall associated with the source and/or destination account (e.g., via registration process 300). For example, user 110 may register with system 131 to participate in the shortfall event processes by providing a registration request to server 132 via client device 102. In one aspect, server 132 may provide an inquiry to client device 102 requesting a response from user 110 whether to opt-in to the shortfall process. In other embodiments, database 134 may store a previous response from user 110 or information from a profile of user 110 indicating whether user 110 has opted-in. Server 132 may determine that the user has opted-in based on information obtained as a result of registration process 300. In some embodiments, if server 132 determines that the user has previously refused to opt-in, server 132 may execute software instructions that generate and provide to client device 102 a message indicating that there is an impending shortfall event and request an updated response from user 110.

In certain aspects, if server 132 determines that user 110 has not opted-in (e.g., step 616; No), server 132 may generate and transmit a message to client device 102 including a confirmation of the determined shortfall using any of the exemplary techniques outlined above (e.g., in step 618). For example, server 132 may provide the message via email, text message, or other types of electronic communications. In certain aspects, server 132 may perform processes that consider preconfigured preferences of user 110 to determine whether to provide the message and the format of the message. For example, server 132 may transmit a message to client device 102 that may be rendered in an interface displayed in a display device including a customized message based on the type of transfer, type of destination account, etc. (e.g., “Insufficient Funds in checking account; unable to transfer $1000.00 to landlord account”). Exemplary process 600 is then complete.

Referring back to step 616, if server 132 determines that user 110 has registered and opted-in (e.g., step 616; Yes), server 132 may access a profile associated with user 110 (e.g., in step 620). The profile may be a data structure stored in memory (e.g., database 134) that includes information about the user, including an indication of whether user 110 has an existing investment account line of credit. In certain aspects, the user profile may be generated based on information obtained and processed during registration process 300.

At step 622, server 132 may determine whether a shortfall account exists for user 110. If a shortfall account does not exist (e.g., step 622; No), server 132 may be configured to perform processes to establish the shortfall account for user 110 (e.g., at step 624). In certain aspects, as described above, the shortfall account may be funded from a credit facility that includes, but is not limited to, a line of credit, a loan, a demand product, an overdraft protection service, funds borrowed from family and/or friends, funds provided by syndicated crowdsourcing, micro-financing sources, and any additional or alternate borrowing facility provided by a financial institution or non-financial entity. For example, server 132 may perform processes consistent with the operations disclosed above in connection with registration process 300 to establish the credit facility and fund the shortfall account.

If, however, the shortfall account exists (e.g., step 622; Yes), server 132 may be configured to perform processes that transfer funds from the shortfall account to the destination account (e.g., in step 626). For example, server 132 (or other component of system 131) may perform processes to transfer $800.00 to a checking account having a balance of $200.00 to cover a shortfall for a $1000.00 scheduled payment to be made using the checking account. In other aspects, and consistent with the disclosed embodiments, server 132 may be configured to perform processes in step 626 to transfer funds from the shortfall account to the source account associated with the shortfall. In some instances, the transfer of funds from the shortfall account to the source account enables server 132 to initiate the scheduled funds transfer from the source account in an amount equivalent to the previously established funds transfer amount.

At step 628, server 132 may perform processes that transfer funds from the source account to the destination account. In one embodiment, server 132 may perform the funds transfer in a manner similar to the operations disclosed above.

Server 132 may also establish a repayment schedule for the shortfall account (e.g., step 630). For example, server 132 may perform processes that establish a repayment schedule in a manner similar to the operations disclosed above. In one embodiment, the payment schedule may consist of multiple payments scheduled from the source account with interest. For example, to cover a credit line balance of $800.00, payments of $100.00 plus interest may be scheduled each month for eight months. In other embodiments, the payment plan may consist of a single payment from the source account on a set date or at the demand of business entity 130. If payments are made within a predetermined amount of time, interest may not be due. In other embodiments, another account such as an investment account or other savings account may make payments on the balance of the line of credit.

In response to the established payment schedule, exemplary process 600 may pass back to step 608, and server 132 may generate and transmit a notification message to client device 102. In one example, server 132 may generate and provide the notification following a successful transfer of funds from the source account to the destination account (e.g., at step 612 or step 628). In other embodiments, server 132 may generate and provide the notification in a message via email, text message, etc. based on pre-established condition(s) programmed for server 132, the preferences of user 110, etc. For example, server 132 may transmit a message to client device 102, such as, “Successful transfer of $1000.00 from checking to landlord at 4:00 PM EST on Apr. 1, 2014.” Other types of messages may be conveyed in the notification(s) provided by the disclosed embodiments. Exemplary process 600 is then complete.

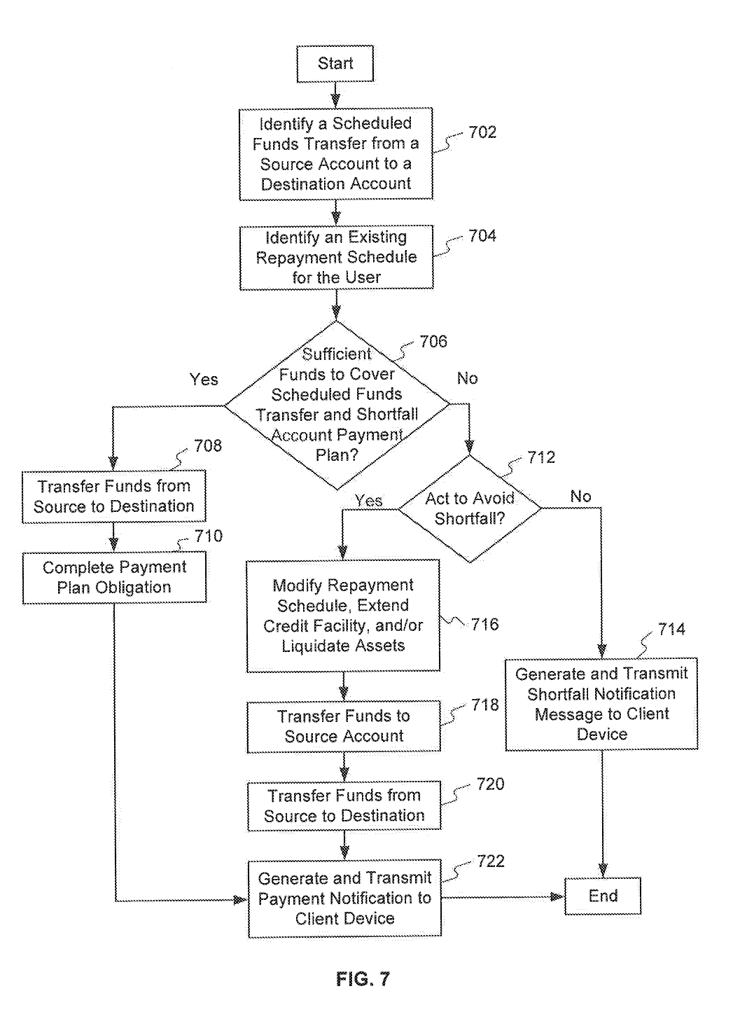

FIG. 7 illustrates an exemplary financial account provisioning and repayment process 700, consistent with disclosed embodiments. In certain embodiments, server 132 may be configured to perform one or more operations of process 700.

At step 702, server 132 may identify a scheduled funds transfer from a source account to a destination account. Server 132 may, in certain aspects, perform operation 702 in a manner similar to the operations performed in connection with step 601 of exemplary process 600, as described above.

At step 704, server 132 may identify an existing repayment schedule for user 110. In some aspects, the existing repayment schedule may be associated with a credit facility that funds a shortfall account established on behalf of user 110 (e.g., using any of the exemplary processes described above). In certain aspects, as described above, credit facility may include, but is not limited to, a line of credit, a loan, a demand product, an overdraft protection service, funds borrowed from family and/or friends, funds provided by syndicated crowdsourcing, micro-financing sources, and any additional or alternate borrowing facility provided by a financial institution or non-financial entity.

Further, in step 704, server 132 may perform operations(s) that determine the amount and number of any previous shortfalls that the shortfall account may have covered. In one aspect, the repayment schedule may indicate payment amounts and dates for repayment. In one embodiment, server 132 may perform operations that access and search a memory that stores information reflecting the repayment schedule, such as database 134 in association with user 110.

At step 706, server 132 may determine whether the source account includes funds sufficient to cover the scheduled transfer, as well as any concurrent payment plan obligations for the shortfall account. For example, user 110 may deposit additional funds into the source checking account to cover a $1000.00 scheduled recurring rent payment and an outstanding $800.00 on the shortfall account credit facility (e.g., the shortfall account credit line), which was used to cover the previous month's rent payment. In certain aspects, user 110 may deposit the addition funds through operations provided by system 131 and via client device 102, such as through an online transfer operation via an online banking portal or the like that may be provided by system 131,

If server 132 determines that the source account includes sufficient funds (e.g., step 706; Yes), server 132 may perform operations that transfer the scheduled payment from the source account (e.g., in step 708). In one aspect, server 132 (or another component of system 131) may perform a funds transfer from the source account to the shortfall account as a payment in accordance with the shortfall account repayment schedule, which may satisfy the payment plan obligation (e.g., in step 710).

At step 722, server 132 may generate and transmit a notification to client device 102 that may be displayed for user 110. Server 132 may transmit the notification responsive to a successful transfer of funds from the source account to the destination account (e.g., in step 710). In certain embodiments, server 132 may send a message via mobile application, email, text message, based on pre-established condition(s), preference(s) of user 110, etc. Exemplary process 700 may then be complete.

Referring back to step 706, if server 132 determines that the source account includes insufficient funds (e.g., step 706; No), server 132 may determine whether or not to act to avoid a shortfall (e.g., in step 712). This determination may be made based on user preferences, or based on pre-established conditions assessed by server 132, based on, for example, the shortfall amount and availability of any increases to the shortfall account credit facility (e.g., the shortfall account credit line). For example, the shortfall account credit line may be increased from $1000.00 to $1500.00 to cover a subsequent shortfall event.

If server 132 determines that no action is to be taken (e.g., step 712; No), server 132 may generate and provide a notification message to client device 102 that may indicate that the shortfall occurred (step 714). For example, server 132 may transmit the notification for display on client device 102 via a mobile application executing on client device 102, email, text message, etc. Exemplary process 700 may then be complete.

If, however, server 132 determines that action is to be taken to avoid a shortfall, (e.g., step 712; Yes), server 132 may perform processes that perform an appropriate action (e.g., a modification to the repayment schedule, an extension to shortfall account credit facility, a liquidation of one or more assets held in the source accounts, etc.) to generate sufficient funds (e.g., in step 716). As described below, server 132 may determine a modification option may be based on user preference(s), investment account holdings, market conditions, the amount of funds needed, etc. Further, any of the appropriate actions described below in reference to step 716 may be performed in combination to avoid shortfall for the scheduled funds transfer and/or the repayment schedule obligation

For example, the source account may include funds sufficient to make either the repayment schedule obligation or the scheduled funds transfer, but not both. Furthermore, the source account may include funds sufficient to perform neither the repayment schedule obligation nor the scheduled funds transfer. In some aspects, server 132 may execute software that performs processes that considers such conditions to determine the action to be taken to avoid the shortfall.

In one example, server 132 may perform processes in step 716 that extend the shortfall account credit facility (e.g., a shortfall line of credit) to cover the shortfall and repayment schedule obligation. In another example, server 132 may perform processes in step 716 that alter the repayment schedule, such as to postpone a payment. In other embodiments, server 132 may generate information that is provided to a component that manages the shortfall account (e.g., other programs executed by server 132 or other component of system 131, etc.) to avoid a penalty fee that maybe typically applied to late or insufficient payment amounts for the shortfall account payment. In other aspects, server 132 may perform processes that generate information that is used to apply a penalty for the action taken (e.g., increase interest amount, penalty fee, etc.), For example, if a source checking account has a $1100.00 balance with a scheduled rent payment transfer of $1000.00 and a repayment schedule of $200.00, the repayment schedule payment may be reduced to $100.00 so that there are sufficient funds to cover all of the necessary transfers.

In another example, the shortfall account credit facility (e.g., the shortfall account credit line) may be extended to cover the shortfall and repayment schedule obligation. Any of the above-discussed procedures for step 716 may be performed in combination to avoid shortfall for the scheduled funds transfer and/or the repayment schedule obligation.

In other aspects, in step 716, one or more assets held by user 110 in the investment account may be managed to create liquidity and cover at least a portion of shortfall amount, and additionally or alternatively, to finance at least a portion of the repayment schedule obligation. For example, as described above, server 132 may execute software processes that determine a strategy for liquidating one or more assets held by user 110 (e.g., MMAs, shares of common stocks, bonds, etc.) to cover portions of the shortfall amount and/or the repayment schedule obligation. In certain aspects, server 132 may determine the liquidation strategy based on factors that include, but are not limited to, liquidity characteristics of the assets, penalties associated with liquidating the assets, preferences of user 110 regarding liquidation of the assets (e.g., as provided to server 132 through client device 102), and/or default or predetermined rules regarding liquidation established by system 131. In certain embodiments, server 132 may generate the liquidation strategy to facilitate the scheduled funds transfer and/or the repayment schedule obligation in a manner that reduces current and future costs incurred by user 110 and maintains an acceptable rate of return on the remaining assets held by user 110.

In one embodiment, server 132 may optionally perform processes in step 716 that manage the investment account of user 110 to create additional dividend income. For example, server 132 may be configured to generate instructions to switch funds that do not produce dividends to funds that produce a dividend sufficient to generate funds needed for a repayment schedule on the shortfall account. For instance, server 132 may be configured to generate instructions to sell shares of a stock that has not historically produced a dividend and use the resulting funds to purchase shares of a stock that historically produces quarterly dividends. The additional dividend income may provide funds for the shortfall account repayment schedule or a planned funds transfer. Server 132 may be configured to manage the investment account of user 110 based on preferences provided by user 110 (e.g., during process 300, etc.). Server 132 may generate and transmit a message to client device 132 that requests the authorization of user 110 in order to manage the funds of the investment account. Server 132 may also generate and transmit a message to client device 132 indicating a confirmation of the change, including, for example, the asset that was sold, the sell price, a timestamp for the sell, the asset that was purchased, the purchase price, a timestamp for the purchase, and the expected dividend for the purchased asset. For example, server 132 may generate and transmit a message that may state, “50 shares of Stock A sold for $5000.00 ($100.00 per share) at 2:30 PM EST; 200 shares of Stock B purchased for $5000.00 ($25.00 per share) at 2:31 PM EST; historical dividend for Stock B is approximately $1.00 per share per month.”

In one embodiment, server 132 may optionally perform processes that determine a source of other funds to cover a pending repayment amount shortage, and transfer the appropriate funds to the source account (e.g., in step 718).

At step 720, server 132 may perform processes that perform a fund transfer from the source account to the destination account.

At step 722, server 132 may generate and transmit a notification to client device 102 that may be displayed for user 110. Server 132 may transmit the notification responsive to a successful transfer of funds from the source account to the destination account (e.g., in step 720). In certain embodiments, server 132 may send a message via mobile application, email, text message, based on pre-established condition(s), preference(s) of user 110, etc. For example, the shortfall account may be funded by a line of credit (e.g., established using any of the techniques described above), and server 132 may transmit a message to client device 102 stating, “Successful transfer of $1000.00 from checking to landlord at 4:00 PM EST on May 1, 2014; successful scheduled repayment of $200.00 on investment account credit line at 4:10 PM EST on May 1, 2014.” Exemplary process 700 is then complete.

In some aspects, client device 102, in cooperation with system 131, may provide user 110 with interfaces that identify a current state of one or more accounts held by user 110 (e.g., an investment account, a checking or savings account, and/or a shortfall account), that identify one or more scheduled funds transfers between these accounts, and further, that notify user 110 of anticipated shortfall events associated with these transfers. For example, server 132 may execute software processes to monitor the accounts held by user 110 and the scheduled transfers to identify potential shortfall events, and provide notifications of the potential shortfall events to client device 102, which may render and present the notifications to user 110. In some aspects, the notifications presented to user 110 may, for example, identify the one or more of the accounts held by user 110, current balances associated with the accounts, and the one or more scheduled transfers. Further, in other aspects, the presented notifications may also identify a potential shortfall event (e.g., due to a scheduled transfer), and/or that the shortfall account has been depleted by prior shortfall events and may be unavailable to reconcile future shortfalls.

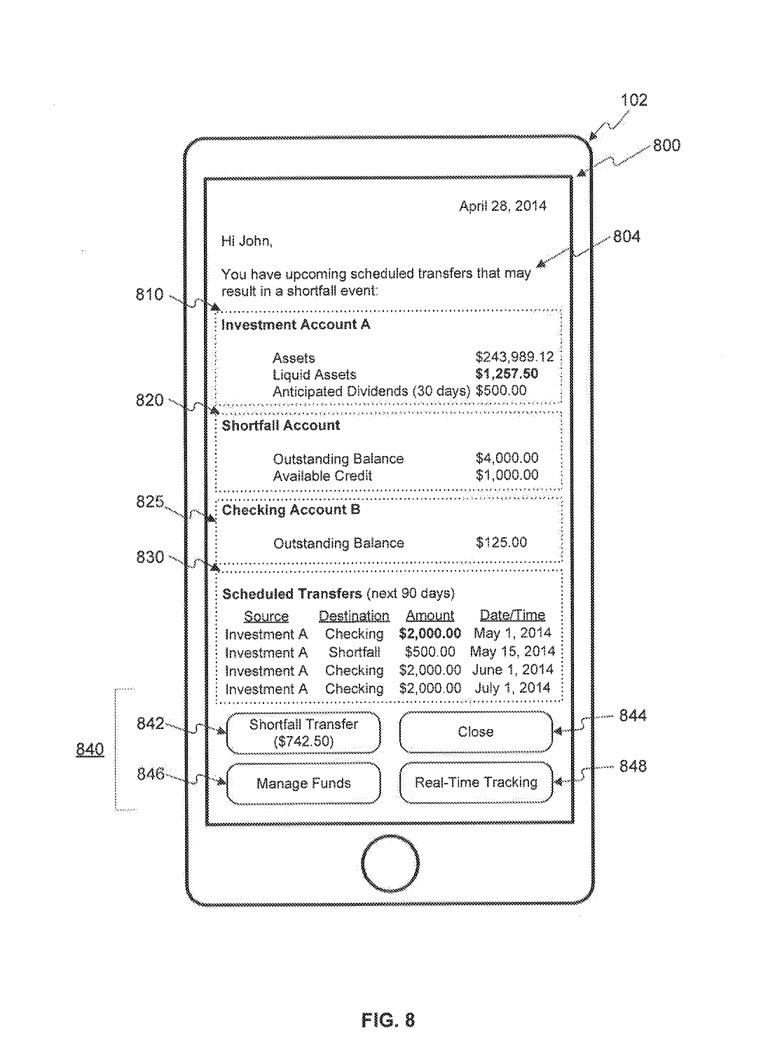

FIG. 8 illustrates an exemplary notification interface 800 presented to user 110 by client device 110, in accordance with disclosed embodiments. In FIG. 8, interface 800 may include information identifying an account event (e.g., account event information 804), one or more investment accounts held by user 110 (e.g., investment account information 810), one or more shortfall accounts available to user 110 (e.g., shortfall account information 820), one or more checking accounts held by user 110 (e.g., checking account information 825), and one or more scheduled funds transfers (e.g., transfer information 830). In certain aspects, client device 102 may obtain the investment account information 810, shortfall account information 820, and transfer information 830 (e.g., from a local storage and/or from system 131 across network 120), and may generate and render notification interface 800 for presentation to user 110.

In some embodiments, account event information 804 may identify a reason that client device 102 presented interface 800 to user 110. For example, as illustrated in FIG. 8, account event information 804 may identify a potential shortfall event, e.g., that “You have upcoming scheduled transfers that may result in a shortfall event.” In other aspects, account event information 804 may identify a scheduled funds transfer triggering the shortfall event, a strategy for remedying the shortfall event, and further, one or more actions that collectively establish the strategy.

Investment account information 810 may identify a current state of one or more investment accounts held by user 110. In certain aspects, information 810 may identify each of the investment accounts held by user 110 and may provide information describing a current status of each investment account, which includes, but is not limited to, a current valuation of the assets in each investment account, an amount of the asserts that are currently liquid, any anticipated or announced dividends, and a largest asset in each investment account. For example, as illustrated in FIG. 8, investment account information 810 indicates that user 110 holds “Investment Account A” including total assets of $243,989.12, of which $1,257.50 are liquid. Further, investment account information 810 also indicates that Investment Account A expects an anticipated dividend of $500 in the next thirty days.

Shortfall account information 820 may, for example, identify a current state of a shortfall account held by user 110 (e.g., a line-of-credit established by system 132 using the exemplary processes described above). In an embodiment, shortfall account information 820 may include, but is not limited to, information identifying an outstanding balance on the line-of-credit, an amount of available credit, a period of validity for the line-of-credit, a next repayment due date for the outstanding balance, and a penalty fee for missing the next repayment. For example, in FIG. 8, shortfall account information 820 indicates a $4,000.00 outstanding balance and an available balance of $1,000.00 for the shortfall account held by user 110.

Further, checking account information 825 may identify a current state of one or more checking accounts held by user 110. For example, as illustrated in FIG. 8, checking account information 825 indicates that user 110 holds “Checking Account B” having a current outstanding balance of $125.00.

In some aspects, scheduled funds transfer information 830 may list one or more funds transfers scheduled between the accounts held by user 110 (e.g., Investment Account A and/or Checking Account B). In an embodiment, information 830 may identify funds transfers scheduled during a particular period of time (e.g., one month, 90 days, 6 months, one year, etc.), which may be selected by user 110 or specified by client device 102 or system 131. Further, in some embodiments, funds transfer information 830 may include information specifying each of the listed funds transfers, which includes, but is not limited to, a source account, a destination account, an amount of money to be transferred, a date and time of the transfer, whether the transfer is recurring, and whether the transfer is part of a repayment plan.

For example, and as illustrated in FIG. 8, funds transfer information 830 may indicate that user 110 scheduled (i) a first funds transfer of $2,000 from “Investment Account A” to a “Checking” account on May 1, 2014; (ii) a second funds transfer of $500 from Investment Account A to a “Shortfall” account on May 15, 2014 (e.g., as part of a repayment schedule); (iii) a third funds transfer of $2,000 from Investment Account A to the Checking account on Jun. 1, 2014; and (iv) a fourth funds transfer of $2,000 from Investment Account A to the Checking account on Jul. 1, 2014.

Further, by way of example, interface 800 may highlight the scheduled funds transfer within information 830 that causes the potential shortfall event (e.g., interface 800 may present the $2,000 transfer scheduled for May 1, 2014, in bolded text). Interface 800 may also highlight other relevant items, such as the lack of available credit in the shortfall account or the amount of liquid assets in the investment account, which may result in the potential shortfall event. In certain aspects, interface 800 may highlight items using bold font, underlining, italics, background color, text color, shadowing, outlining, and/or visual effects.

Notification interface 800 may, in some embodiments, also include regions (e.g., regions 840) that, upon selection by user 110, enable user 110 to manage the potential shortfall, the accounts held by user 110, and/or the funds transfers scheduled by user 110. For example, as illustrated in FIG. 8, regions 840 may include a “cover shortfall” regions 842, a “close” regions 844, a “manage accounts” regions 846, and a “real-time tracking” regions 848.

In some embodiments, “cover shortfall” region 842 may allow user 110 to request an initiation of a strategy determined by server 132 to cover an amount of the potential shortfall event. As described above, server 132 may determine an action or set of actions to cover the shortfall amount based on, for example, an available balance of the shortfall account, preferences of user 110, and characteristics of specific assets held by user 110. In certain aspects, regions 842 may present information that identifies the determined strategy, and may enable user 110 to request implementation of that strategy through a single “click.” For example, to cover a $742.50 shortfall associated with the funds transfer scheduled for May 1, 2014, server 132 may determine to transfer funds from the Shortfall account to Investment Account A, and regions 842 may present information specifying the determined strategy. In certain aspects, user 10 may press, click, or otherwise select region 842, and client device 102 may transmit information to system 131 requesting implementation of the determined strategy, as described above.

In FIG. 8, user 110 may press, click, or otherwise select “close” region 844, which may request that client device 102 close notification interface 800. In certain aspects, and upon selecting region 844, client device 102 may present to user 110 a previously displayed screen or interface.

In some embodiments, user 110 may press, click, or otherwise select “manage funds” region 846 to view additional interface elements and manually manage one or more of the investment accounts, shortfall accounts, and scheduled transfers to remedy the potential shortfall event. For example, by selecting region 846, client device 102 may present additional interface elements (not shown) that enable user 110 to request that system 131 liquidate assets, transfer funds to and from the shortfall account, and cancel or modify scheduled funds transfers.

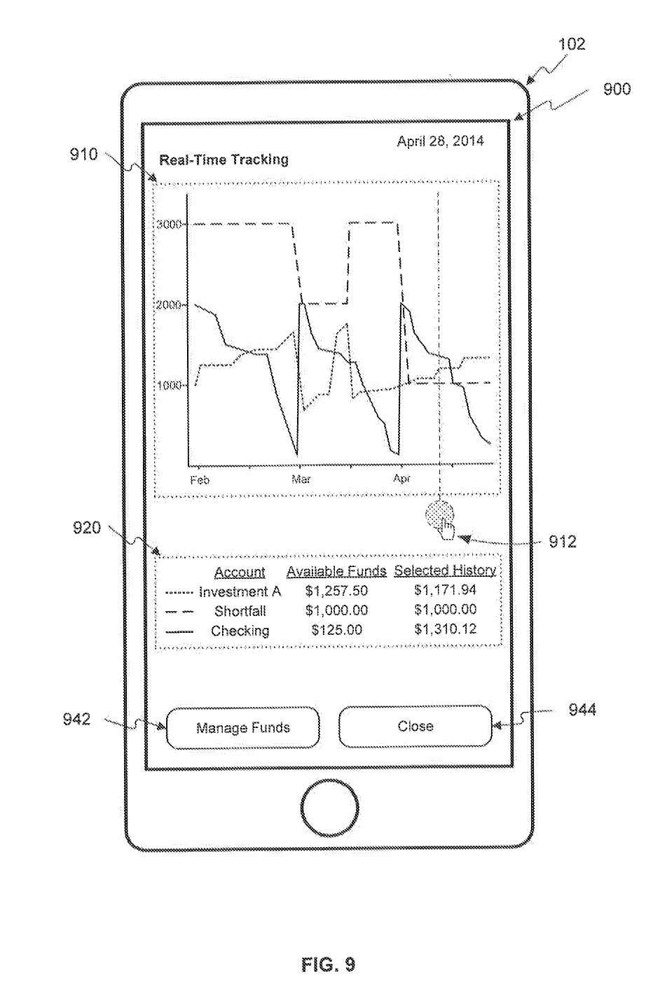

Further, in some aspects user 110 may press, click, or otherwise select “real-time tracking” region 848 to view and interact with real-time account data on one or more additional interface elements (e.g., through a “real-time tracking” interface presented by client device 102). FIG. 9 is an exemplary real-time tracking interface 900, which client device 102 may present to user 110 by client device 102 in accordance with disclosed embodiments. For example, in FIG. 9, tracking interface 900 may include real-time and historical data describing one or more investment, checking, and shortfall accounts held by user 110, which may be presented within graph 910 and account information 920. As described above, client device 102 may generate and present tracking interface 900 to user 110 in response to a selection of region 848 of interface 800 by user 110.

In some embodiments, graph 910 may present a graphical view of the balances of one or more accounts held by user 110 over a corresponding time period (e.g., the last hour, day, week, month, quarter, year, etc.). For example, as illustrated in FIG. 9, graph 910 may include separate traces for Investment Account A (e.g., a short dashed line), the Shortfall account (e.g., a long dashed line), and a Checking account (e.g., a solid line). The disclosed embodiments are not limited to such exemplary visual effects, and in other embodiments, graph 910 may assign any additional or alternate coloring and/or visual effect to the traces corresponding to user 110's accounts. Further, in some aspects, the scale and/or boundaries of either axis of graph 910 (e.g., the temporal period represented by the x-axis or the balances represented on the y-axis) may be modified or specified by user 110 using interface 900.

Further, in some embodiments, account information 920 may provide a listing of the one or more accounts held by user 110 and various characteristics of these accounts (e.g., current and/or historical balance information). In certain aspects, user 110 may position slider 912 at a particular temporal position within graph 910 (e.g., Apr. 13, 2014), and account information 920 may provide both current balances for the accounts of user 110 and historical balances of these accounts at the particular temporal position. By way of example, and upon user 110's selection of Apr. 13, 2014, as the particular temporal position, client device 102 may transmit a request for current account information and account information from Apr. 13, 2014 to system 131, and system 131 may provide the requested account information in a corresponding response (e.g., upon accessing stored account data 138 of database 134).

For example, as shown in FIG. 9, account information 920 indicates that Investment Account A has $1,257.50 in available funds, that the Shortfall account has $1,000 in available funds, and that the Checking account has $125 in available funds. Further, at the selected date of Apr. 13, 2014, account information 920 in FIG. 9 illustrates that $1,171,94 were available in Investment Account A, $1,000 were available in the Shortfall account, and $1,310.12 were available in the checking account.

In some embodiments, user 110 may press, click, or otherwise select “manage funds” region 942 to view additional interface elements and manually manage one or more of the investment accounts, shortfall accounts, and scheduled transfers to remedy a potential shortfall event. For example, by selecting region 942, client device 102 may present additional interface elements (not shown) that enable user 110 to request that system 131 liquidate assets, transfer funds to and from the shortfall account, and cancel or modify scheduled funds transfers.

Further, in FIG. 9, user 110 may press, click, or otherwise select “close” region 944, which enables client device 102 to close notification interface 900. In certain aspects, and upon clicking on region 944, client device 102 may present to user 110 a previously displayed screen or interface.

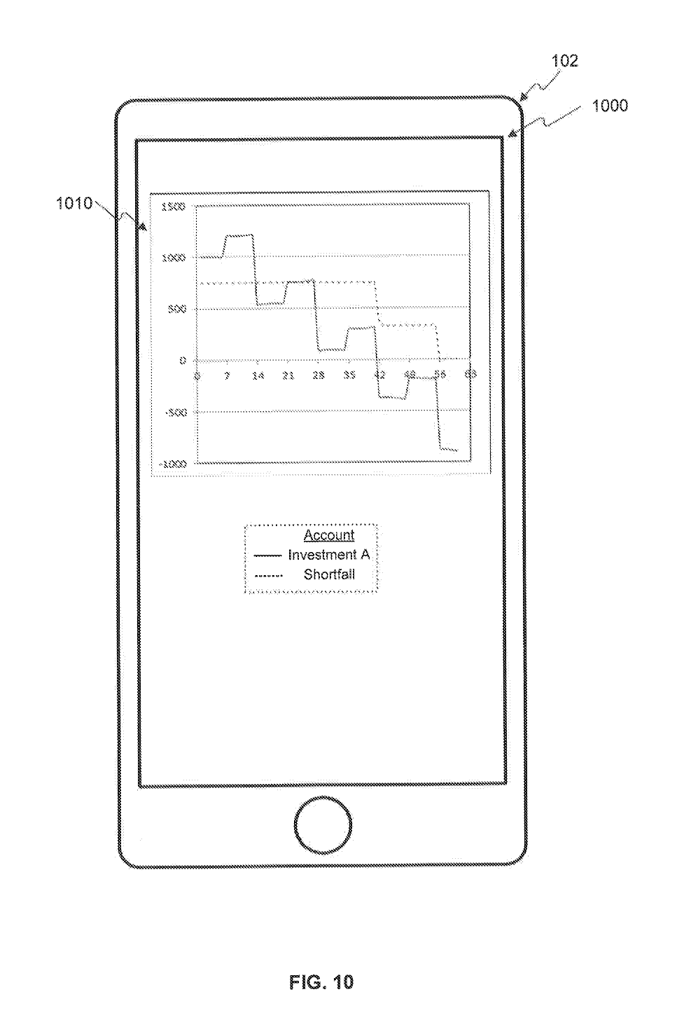

In other aspects, client device 102, in cooperation with system 131, may provide user 110 with interfaces that enable user 110 to view a time-dependent effect of scheduled transfers on an investment account and a shortfall account. For example, user 110 may assume that an investment account having a certain initial balance (e.g., $1,000), which earns an average interest rate of 5% and which receives income of $200 every seven days, may provide adequate support for a bi-monthly withdrawal (e.g., every fourteen days) of $875, for example, to a checking account of user 110 or to an account of a third-party to pay a bill. FIG. 10 illustrates an exemplary interface 1000 that enables user 110 to view an impact of scheduled transfers on an investment account subject to specific rates of return and income infusions, in accordance with the disclosed embodiments. In some aspects, interface 1000 may be rendered and presented to user 110 based on information locally available to client device 102, and additionally or alternatively, based on information received from system 131.

In FIG. 10, interface 1000 indicates that “Investment Account A” of user 110, which had an initial balance of $1,000, an average rate of return of 5%, and weekly income infusions of $200, supports two bi-monthly withdrawals (e.g., on the fourteenth and twenty-eighth day) without encountering a shortfall. Sever 132 may, however, identify a potential shortfall event on the forty-second day, and the third scheduled withdrawal of $875 would cause a deficit in Investment Account A. As indicated in FIG. 10, server 132 may implement a strategy that draws on a portion of a shortfall account established for user 110, which includes an initial balance of $750, to facilitate the third withdrawal. As described above, server 132 may establish the shortfall account and corresponding line-of-credit based on, among other things, specific holdings within Investment Account A and/or a propensity of user 110 for shortfall events, and may further establish a repayment schedule for user 110.

As FIG. 10 illustrates, server 132 may identify a subsequent shortfall event prior to the fourth withdrawal of $875, which occurs on the fifty-sixth day. For example, the fourth withdrawal would exhaust the shortfall account of user 110. As described above, in order to continue regular withdrawals and continue to service repayment plan obligations, server 132 may determine a strategy that includes, but is not limited to, extending the line-of-credit, liquidating at portion of assets held within Investment Account A, and modifying a withdrawal schedule.

The embodiments described above enable user 110 to interactively and adaptively view, through interface 1000, impacts of scheduled withdrawals on an investment account and/or an established line of credit. In certain aspects. user 110 may elect to modify one or more of the scheduled withdrawals or the funds deposited within the investment account to better tune a desired stream of payments to a current financial state of accounts held by user 110.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

For example, the disclosed embodiments may be configured to determine repayment schedule parameters based on subsequent revenue generated by the user's investment account that was the cause of an initial shortfall event. The disclosed embodiments may perform processes. For instance, a retirement account of user 110 may typically generate monthly revenue of $1000.00 a month. The investment account that receives that receives those funds may be a source account that is subject to a scheduled funds transfer to a destination account to cover a periodic monthly payment (e.g., mortgage, etc.). If a shortfall account has been established in accordance with the disclosed embodiments, and used to cover a shortfall event in connection with the investment account, the disclosed embodiments may be configured to automatically determine and establish a repayment schedule for paying back a credit facility applied from the shortfall account to cover the shortfall event. In some instances, the disclosed embodiments may be configured to apply any revenue deposited into the investment account that is above the $1000.00 amount typically used for the scheduled funds transfer. Thus, for example, system 131 may be configured to identify when the investment account has received an additional amount (e.g., $1500.00) in a given month, and automatically determine and perform a funds transfer of $500.00 from the investment account to the shortfall account as a payment towards the credit facility of the shortfall account. Additionally, the disclosed embodiments may be configured to determine and create a shortfall account that is secured against the investment account revenue, the underlying investment holdings used to generate the revenue (e.g., retirement account), etc. While these exemplary embodiments are disclosed in the context of a subsequent shortfall event (e.g., a shortfall account has been previously used), the strategies employed in subsequent shortfalls may be used in an initial shortfall (e.g., in step 507).

Further, one or more exemplary techniques described above enable server 132 to establish a shortfall account associated with a line-of-credit secured against investment assets held by user 110 in one or more investment accounts, to transfer funds from the shortfall account to a source account to facilitate a scheduled funds transfer to a destination account, and further, to establish and modify payment schedules based on investment income associated with the one or more investment accounts. The disclosed embodiments are not, however, limited to shortfall accounts funded by exemplary credit lines secured against user 110's investment assets, and in further embodiments, one or more of the exemplary techniques described above may enable server 132 to establish a shortfall account associated with any additional or alternate credit facility available to user 110 and/or business entity 130, and further, appropriate to amounts, types, volatilities, and liquidities of user 110's investment assets. In some aspects, as described above, credit facilities consistent with the disclosed embodiments may include, but are not limited to loans, demand products, overdraft protection services, and/or borrowing facilities provided to user 110 by financial institutions and similar entities. Further, additional credit facilities consistent with the disclosed embodiments may include, but are not limited to funds borrowed from family members or close friends, funds obtained from crowdsourcing and other sources of syndicated investment funds, funds borrowed from micro-financing entities, and/or other credit facilities provided by non-financial entities, as described above.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

What is claimed is:

1. A system, comprising:
a memory storing instructions; and
one or more processors configured to execute the instructions to perform operations including:
identifying a scheduled funds transfer from an investment account of a user to a destination account, the scheduled funds transfer being associated with a funds transfer amount determined based on expected periodic returns from the investment account;
determining a shortfall amount associated with a shortfall event, the shortfall event indicating that the funds transfer amount exceeds an amount of funds available from the investment account, and the shortfall amount reflecting a difference between the amount of available funds and the funds transfer amount;
establishing a shortfall account for the user that includes a credit facility providing at least the shortfall amount;
performing operations that trigger an automated funds transfer of at least a first portion of the shortfall amount from the shortfall account to the destination account; and
determining a repayment schedule for the shortfall account, based on excess funds remaining after one or more future scheduled funds transfers.

2. The system of claim 1, wherein the shortfall account is secured against the investment account.

3. The system of claim 1, wherein the credit facility comprises at least one of a line of credit, a loan, a demand product, an overdraft protection service, a borrowing facility, a source of crowdsourcing funds, a source of micro-financing, a friend capable of providing funds, or a family member capable of providing funds.

4. The system of claim 1, wherein:
the credit facility comprises a line of credit; and
the at least one processor is further configured to perform operations including establishing the line of credit for the user based on one or more investment holdings associated with the investment account, the shortfall account having an associated a shortfall balance and period of validity.

5. The system of claim 1, wherein the at least one processor is further configured to perform operations including:
generating one or more electronic commands to liquidate at least a portion of the holdings of the investment account to obtain funds corresponding to at least a second portion of the shortfall amount; and
generating one or more electronic commands to transfer the obtained funds to the destination account.

6. The system of claim 1, wherein the at least one processor is further configured to perform operations including identifying the liquidated portion of the holdings based on at least one of a liquidation characteristic of the holdings, a penalty associated with the liquidation, a rate of return associated with the holdings, a user preference, or an interest rate associated with the repayment schedule.

7. The system of claim 1, wherein the at least one processor is further configured to perform operations including:
performing operations that trigger the funds transfer of the shortfall amount from the shortfall account to the destination account; and
providing a notification to a device of the user indicating that the shortfall account was used to cover the shortfall amount.

8. The system of claim 1, wherein the at least one processor is further configured to perform operations including establishing the shortfall account without liquidating investment holdings of the user.

9. The system of claim 1, wherein the at least one processor is further configured to perform operations including executing the funds transfer in the shortfall amount from the shortfall account to the destination account without liquidating investment holdings of the user.

10. The system of claim 1, further comprising wherein the at least one processor is further configured to perform operations including:
determining a subsequent deposit amount to the investment account following the shortfall event;
determining a first excess fund amount for the investment account that indicates a difference between the amount of available funds from the investment account following the subsequent deposit amount to the investment account and the funds transfer amount;
determining a shortfall account payment amount based on the first excess fund amount;
performing a shortfall account payment funds transfer from the investment account to the shortfall account, for the shortfall account payment amount.

11. The system of claim 10, wherein the shortfall account payment amount is equal to the first excess fund amount.

12. The system of claim 10, wherein shortfall account payment amount is at least a portion of the first excess fund amount.

13. A device, comprising:
a memory storing instructions; and
one or more processors configured to execute the instructions to perform operations including:
obtaining user registration information reflecting a request by a user for a shortfall account, the investment account being associated with a scheduled funds transfer of a funds transfer amount determined based on expected periodic returns from the investment account to a destination account;
providing the request for the shortfall account to a computing system associated with a financial institution, the computing system being connected to the device across a corresponding communications network;
receiving, from the computing system, a shortfall event notification of a shortfall event indicating that the funds transfer amount exceeds an amount of funds available from the investment account;
receiving, from the computing system, a shortfall account payment notification that a shortfall account payment was made from the investment account to the shortfall account of a first excess fund amount that reflects at least a portion of the difference between the funds transfer amount and the amount of available funds following a deposit amount to the investment account subsequent to the shortfall event;
receiving, from the computing system, shortfall repayment schedule information reflecting a repayment schedule for the shortfall account, the repayment schedule being based on excess funds remaining after future scheduled funds transfers from the investment account to the destination account; and
generating one or more instructions to present the received shortfall account payment notification and shortfall repayment schedule information to the user.

14. The device of claim 13, wherein the shortfall account is secured against an investment account for the user.

15. A computer-implemented method, comprising:
identifying, by one or more processors, a scheduled funds transfer from an investment account of a user to a destination account, the scheduled funds transfer being associated with a funds transfer amount determined based on expected periodic returns from the investment account;
determining, by the one or more processors, a shortfall amount associated with a shortfall event, the shortfall event indicating that the funds transfer amount exceeds an amount of funds available from the investment account, and the shortfall amount reflecting a difference between the amount of available funds and the funds transfer amount;
establishing, by the one or more processors, a shortfall account for the user that includes a credit facility providing at least the shortfall amount;
performing, by the one or more processors, operations that trigger an automated funds transfer of at least a portion of the shortfall amount from the shortfall account to the destination account; and
determining, by the one or more processors, a repayment schedule for the shortfall account, based on excess funds remaining after future scheduled funds transfers from the investment account to the destination account.

16. The method of claim 15, wherein the shortfall account is secured against the investment account.

17. The method of claim 15, wherein the credit facility comprises at least one of a line of credit, a loan, a demand product, an overdraft protection service, a borrowing facility, a source of crowdsourcing funds, a source of micro-financing, a friend capable of providing funds, or a family member capable of providing funds.

18. The method of claim 15, wherein:
the credit facility comprises a line of credit; and
creating the shortfall account includes establishing the line of credit for the user based on one or more investment holdings associated with the investment account, the shortfall account comprising a shortfall balance and a period of validity.

19. The method of claim 15, further comprising:
generating, by the one or more processors, one or more electronic commands to liquidate at least a portion of the holdings of the investment account to obtain funds corresponding to a second portion of the shortfall amount; and
generating, by the one or more processors, one or more electronic commands to transfer the obtained funds to the destination account.

20. The method of claim 19, further comprising identifying the liquidated portion of the holdings based on at least one of a liquidation characteristic of the holdings, a penalty associated with the liquidation, a rate of return associated with the holdings, a user preference, or an interest rate associated with the repayment schedule.

21. The method of claim 15, wherein:
the performing comprises performing operations to trigger the funds transfer of the shortfall amount from the shortfall account to the destination account; and
the method further comprises providing, by the one or more processors, a notification to a device of the user reflecting that the shortfall account was used to cover the determined shortfall amount.

22. The method of claim 15, wherein at least one of (i) establishing the shortfall account includes establishing the shortfall account without liquidating investment holdings of the user, or (ii) executing the funds transfer of the shortfall amount from the shortfall account to the destination account without liquidating investment holdings of the user.

23. The method of claim 15, further comprising:
determining, by the one or more processors, a subsequent deposit amount to the investment account following the shortfall event;
determining, by the one or more processors, a first excess fund amount for the investment account that indicates a difference between the amount of available funds following the subsequent deposit amount to the investment account and the funds transfer amount;
determining a shortfall account payment amount based on the first excess fund amount;
performing, by the one or more processors, a shortfall account payment funds transfer from the investment account to the shortfall account, for the shortfall account payment amount.

24. The method of claim 23, wherein the shortfall account payment amount is equal to the first excess fund amount.

25. The method of claim 23, wherein shortfall account payment amount is at least a portion of the first excess fund amount.
